(19) United States
(12) Patent Application Publication
(10) Pub. No.: US 2014/0164093 A1
(43) Pub. Date: Jun. 12, 2014

(54) SYSTEM AND METHOD TO MANAGE AND PUBLISH PROMOTIONS ELECTRONICALLY

(71) Applicant: My Savvy Way, Inc., Brookline, MA (US)

(72) Inventor: Mai Le Libman, Brookline, MA (US)

(73) Assignee: My Savvy Way, Inc., Brookline, MA (US)

(21) Appl. No.: 14/038,722

(22) Filed: Sep. 26, 2013

Related U.S. Application Data
(60) Provisional application No. 61/706,015, filed on Sep. 26, 2012.

(51) Int. Cl. G06Q 30/02

(52) U.S. Cl. CPC G06Q 30/0277
USPC 705/14.39

(57) ABSTRACT

A system and method to find, manage, access and share promotions, such as daily deals and gift cards, electronically is disclosed. The promotions may be in hardcopy (physical) or digital media. The system and method include generating data from promotions, storing that data on a cloud server, and having that data accessible to users with an electronic device, such as a mobile phone, tablet, or computer. The promotion data is indexed and organized based on any one of a user's preferences so that the user can easily retrieve and redeem his promotions. Also disclosed is a system and method for targeted promotion marketing, including a targeting algorithm to provide advertisers information such as offer usage and user demographics. Personalized offers or promotions may be made to users based on a plurality of factors including consumer behavior, preferences, promotion usage, stores and websites shopped at, and geographic location of a user or merchant.

### RELATED APPLICATIONS

This application claims the benefit of U.S. Provisional Application No. 61/706,015, filed on Sep. 26, 2012. The entire teachings of the above application are incorporated herein by reference.

### BACKGROUND OF THE INVENTION

Many consumers use and find promotions as a part of their shopping regiment. Promotions nowadays are in paper form and electronic form, and can be distributed by email, paper communications (“junk mail”, newspaper inserts, flyers, etc.), online offers such as web banners (pop-up and other presentations) and so forth.

Similarly, gift certificates and gift cards are in paper form and electronic form, and distributed in many of the same channels as promotions. In addition, gift certificates and gift cards may be distributed similar to a cash gift.

The rate at which promotions, gift cards and gift certificates are distributed and shared among consumers/shoppers has increased in recent years and consist of billions of offers from manufacturers, retailers, daily deal and flash sites, and promotion aggregators. There is an accumulation of promotions, gift cards and gift certificates in many households and in particular per individual. Finding, managing and maintaining the accumulated promotions, gift cards and gift certificates in an organized manner is a challenge. One arrangement may be ideal for organizing the promotions and gift cards/certificates for safe storage while another arrangement may be preferred for organizing the promotions for ease of use (i.e., search and find at a point of sale).

The variety of promotions, daily deals, and gift cards causes additional problems and frustrations for consumers that ultimately lead to missed savings. To date, there hasn't been a way to consolidate all physical and electronic promotions in a single place, easily and readily accessible anywhere. Further, finding, tracking, and managing promotions, by product, expiration date, or store, is tedious and time-consuming.

Even further, local brick and mortar stores do not always have the resources to adopt to changing consumer behavior. Even with technology readily available to them, merchants simply do not always have the time to create and upload promotions (e.g., products, coupons, sales, gift cards, and offers).

Although many consumers prefer local merchants and shops, many still shop at retailers and big chain stores online because of the accessibility to information, quick shipping, and deals. Information on pricing, selection, and promotions are not easily updated or available on websites from local merchants. For consumers to shop and continue to shop at local stores, merchants need to provide the promotional information to the consumers via the internet or mobile devices.

### SUMMARY OF THE INVENTION

Embodiments of the present invention address the forgoing problems and shortcomings in the art. In particular, the present invention provides a computer-based or mobile-based system and method of finding, managing, and sharing promotions such as products, coupons, gift cards, gift certificates, physical offers and electronic offers. One embodiment provides a social network for savings.

In some embodiments, a computer-based system of managing promotions comprises a source of promotional data, a cloud server and indexing the promotional data, and a web service application programming interface coupling the cloud server to an electronic device of a user and enabling the user through the electronic device to access the promotional data stored on the cloud server.

In another embodiment, the computer-based system further comprises a promotion distribution based on user preferences and predictive models based on the user.

In another embodiment, the promotion data comprises information in physical or electronic form. In another embodiment, the promotional data comprises information from a daily deal. In another embodiment, the promotion data comprises information from a photo of a physical promotion (products, offers, or coupons) uploaded to the cloud server by the user.

In another embodiment, the promotional data comprises information shared by a friend, family member, blogger, retailer, merchant, or other 3^{rd} party.

In another embodiment, the user receives recommended promotions based on a targeting and/or predictive algorithm. In another embodiment, the targeting algorithm predicts and suggests promotions to the user based on preferences, behavior, demographics, types of offers, stores/websites, and/or geographic location of the user.

In another embodiment, the source of promotion data is from a user uploading a photo of a physical offer (e.g., products, offers, coupons, or sales) or a user manually inputting the data.

In another embodiment, the user accessing the promotional data further comprises viewing the data based on any one of the following: name of store issuing the promotion, offer, expiration data, amount of savings, limitations of quantity purchased, type of product, and location.

In another embodiment, the electronic device is any of a mobile device, smart phone, cell phone, tablet, laptop, or personal computer.

In another embodiment, the web service application programming interface further comprises enabling the user to redeem, shop, buy, delete, or share a promotion stored on the cloud server.

In some embodiments, the computer-based system allows consumers to share and upload promotions, such as products, offers, coupons, and sales.

In another embodiment, the computer-based system allows a merchant to distribute one or more tasks to the electronic device of the user to display products and/or promotions for the merchant. In another embodiment, the user earns credits, rewards, points, or predetermined wage amounts as a payment for the user for completing the one or more tasks.

In some embodiments, a computer-based system for promotion marketing comprises a consumer-user database, a promotion database, and a targeting algorithm, wherein the consumer-user database comprises online session information from consumer-users and wherein the offer database comprises local and global information from advertising-users and aggregated metrics based on promotion usage and promotion data.

In another embodiment, the targeting algorithm further generates a personalized promotional offer to consumer-user, wherein the personalized offer is based on any combinations of consumer-user behavior, preferences, usage, stores and websites shopped at, and geographic location of the consumer-user.

In another embodiment, the present invention provides a method of managing and publishing promotions comprising accessing a source of promotional data, indexing a cloud server that stores and indexes said promotional data, and executing a web service application programming interface that couples the cloud server to an electronic device of a user and enabling the user through the electronic device to access the promotional data stored on the cloud server.

The following describes systems and methods to manage, access, and publish promotions electronically by the merchant and consumer users. The system and method help consumers digitally collect, store, track and share personal promotional finds with anyone. The system and method also help consumers curate and personalize physical and electronic promotions using predictive and behavioral algorithms, organize offers of aggregated promotions and buy them on a phone. The system and method also provide retailers with tools for personalized, measurable, and high return on investment marketing initiatives.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of a computer network environment in which embodiments of the present invention may be deployed.

FIG. 2 is a block diagram of computer nodes or devices in the computer network of FIG. 1.

FIG. 3 is a block diagram of the components of the data flow.

FIG. 4 is a block diagram of the components of the marketing module in embodiments.

FIG. 5 is a block diagram of the metadata module in an embodiment.

FIG. 6 is a flowchart of the ranking engine.

FIGS. 7A-7B are examples of a Manufacturer Promotion or Standard Coupon and a Manufacturer Product and Promotion Barcode.

FIGS. 8A-8V are illustrations of the graphical user interface of one embodiment of the invention on a mobile device using iOS.

FIGS. 9A-9C and 11A-11F are examples of the marketing portal user interface.

FIGS. 10A-10G are examples of data collected in the marketing portal.

FIGS. 12A-12D are illustrations of the graphical user interface of another embodiment of the invention on a mobile device using iOS.

### DETAILED DESCRIPTION OF THE INVENTION

A description of example embodiments of the invention follows.

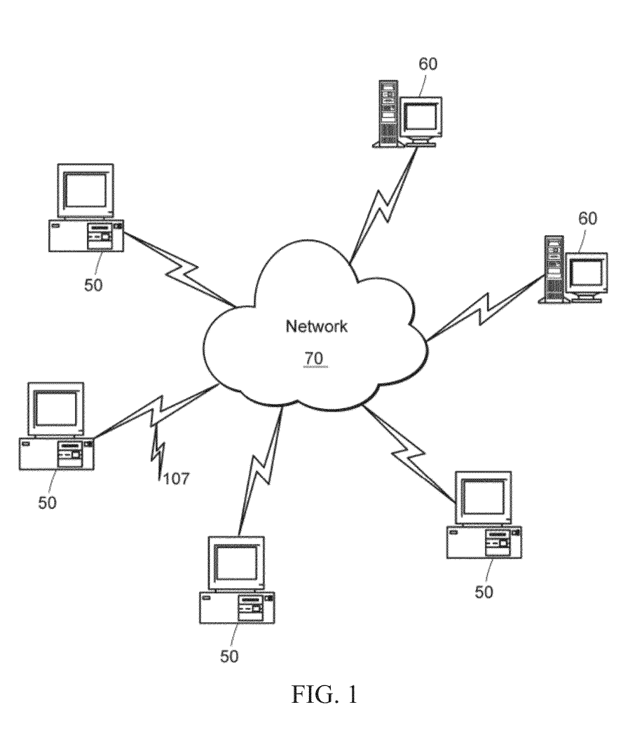

FIG. 1 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 include laptops, desktops, mobile phones, smart phones, TV consoles, game consoles, electronic devices, and the like. Client computers/devices 50 can also be linked through communications network 70 to other computing devices, including other client devices/processes 50 and server computer(s) 60. Communications network 70 can be part of a remote access network, a global network (e.g., the Internet), a multimedia or cable network, a worldwide collection of computers, Local area or Wide area networks, and gateways that currently use respective protocols (TCP/IP, Bluetooth, etc.) to communicate with one another. Other electronic device/computer network architectures are suitable.

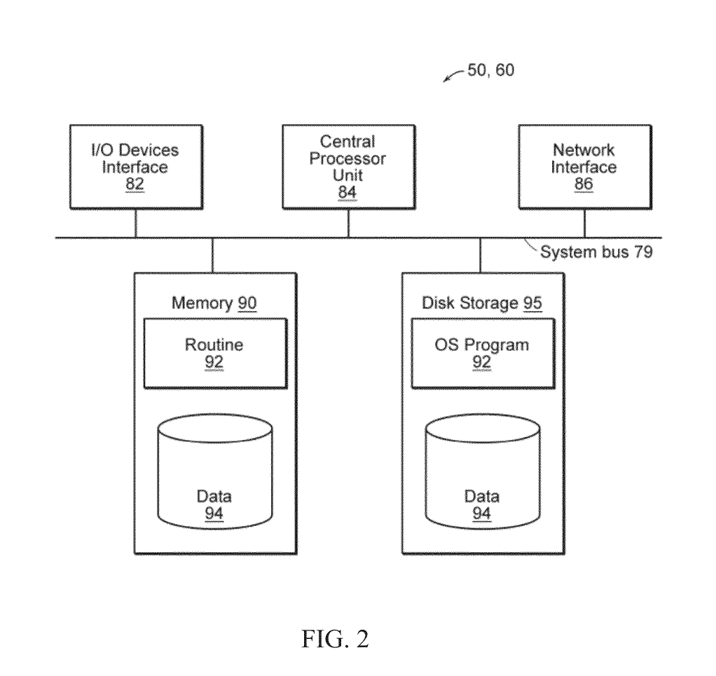

FIG. 2 is a diagram of the internal structure of a computer (e.g., client processor/device 50 or server computers 60) in the computer system of FIG. 1. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 1). Memory 90 provides volatile storage for computer software instructions 92 and data 94 used to implement an embodiment of the present invention (e.g., promotion management, ad targeting and supporting code detailed herein). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

With reference to FIGS. 1 and 2, embodiments comprise (i) a source of promotional data, (ii) a server 60 storing and indexing the promotional data, and (iii) a web service application programming interface (API) coupling the 60 server to an electronic device 50 of a user. The web service API is further configured to enable the user, through the electronic device 50, to access (upload and download) the promotional data stored on the server 60. In a preferred embodiment the server 60 is a cloud server.

The server 60 supports a web portal for users to establish respective accounts and to upload promotions and/or promotional data. The promotional data may comprise information from a physical promotion, electronic promotion, a daily deal (online via the internet for example) or a gift card. The promotional data may comprise information from a photo of a physical promotion uploaded to the server 60 by the user. The promotional data may also be manually inputted by a user. Promotional data is considered to be a “local” offer when the promotional data is provided (uploaded, manually inputted, etc.) by the user, and a “global” offer when the promotional data is otherwise provided to or generated for the user's account.

Embodiments may have a mobile device 50 application or interface to the web portal or other client device/computer 50 interface to the web portal.

The user may be a consumer/shopper. And other users may be advertisers (merchants, agents, and the like). In the process of opening an account on the web portal 60, the respective user creates a profile stating preferences, demographics and so forth. Depending on user type (consumer-user or advertiser-user), the web portal/server 60 provides to the user different functions and operations. For example, the web portal/server 60 provides operations and functions that enable the consumer-user to manually enter promotional data, notes and comments as well as to upload promotional data and images. More importantly the server 60 is configured to enable the consumer-user to organize his promotions according to his preferences and shopping tendencies. Shopping tendencies may include brand loyalty, regularity of shopping per shopping type (e.g., grocery shopping every Saturday morning), stores/websites frequented, geographic locations of stores, and the like.

Upon the consumer-user accessing the promotional data as stored on server 60, the server 60 enables the user to retrieve and/or view promotional data based on any one or combination of: name of store issuing promotions, promotion expiration date, amount of promotional savings, limitations of quantity purchased, type of product, and store location. The web service application programming interface is further configured to enable the user to redeem, delete, or share a promotion stored on the cloud server

The server 60 may further comprise a promotional distribution module that determines promotional distribution based on user preferences and predictive models based on the consumer-user. The server 60 may employ a targeting algorithm to make recommended offers to consumer-users based on their profiles that they maintain on the web portal. The targeting algorithm predicts and suggests promotions to the consumer-user based on any combination of: preferences, behavior, demographics, types of promotions, stores/websites, and geographic location of the user.

A preferred embodiment is described in Example I. There described are data structures, program operations/routines/functions (sample code), and flow of data and control of a promotional management system of the present invention.

Further examples of user-interface (user client) and operations for a consumer-user and user-interface and operations for an advertiser-user (marketing client) are found in Example II.

Example III is an example of the advertising (marketing) module to present offers and advertisements to consumer-user. Also provided is an example of the targeting algorithm, integrating data gathered from use of the promotional management service.

An example of a metadata module is described in Example IV. Key metadata fields, such as product name, manufacturer, description, bar codes, and other information is extracted from a user-supplied data about a product.

Example V is an example of a text parser, taking user-supplied data about a product and to extract metadata fields such as product name, manufacturer, description, and other information.

An example of a web service application programming interface (API) is described in Example VI. Described therein, is an interface to support multiple client versions and updates to the data schema and APIs, and a common interface for component-component communication to reduce dependencies between components. The module also provides multiple security levels for customized data access based on the needs of the client.

Example VII is an example of a web service server specification.

The teachings of all patents, published applications and references cited herein are incorporated by reference in their entirety.

### Example I

### Core Data Schema Overview

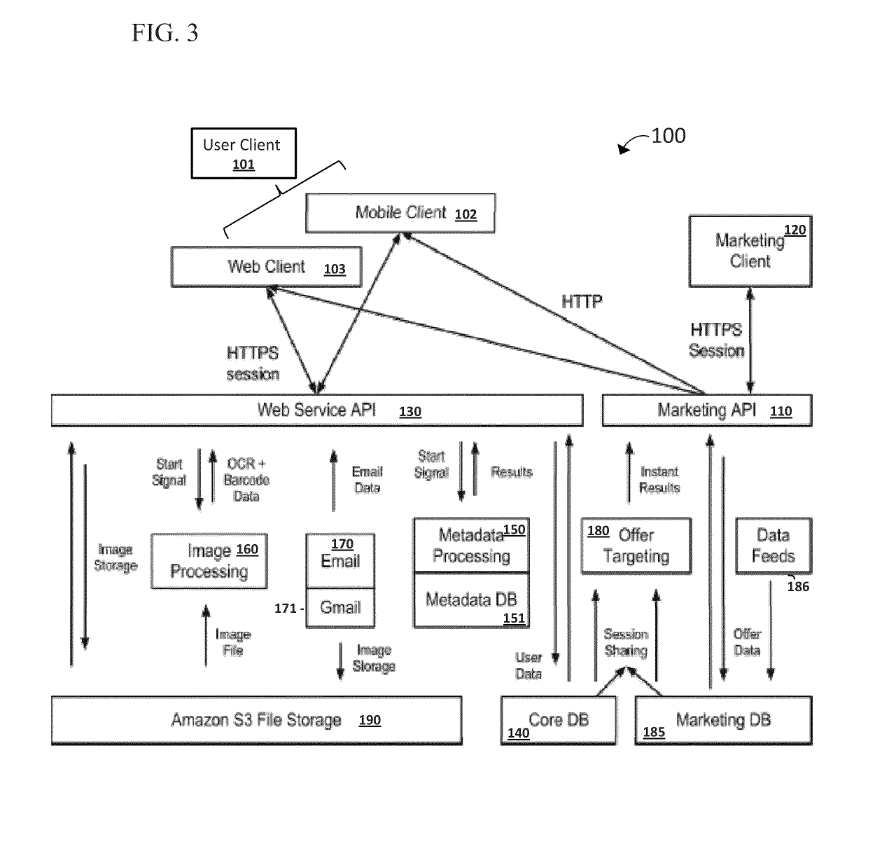

This data schema 100, shown in FIG. 3, covers the core data that is shared amongst client 50 applications, internal data collectors and 3rd party integrators. All of this data is accessible only via the web service layer 130 data is and all security is enforced via the web service API 130. In one embodiment, the data is contained in MySQL tables running within an Amazon RDS MySQL scalable server 190 (at server 60 in FIG. 1 and at data 94 in FIG. 2). Data backups are provided at regular intervals.

### Promotions

These are the base elements for the server 60 site. A few ways to create promotions includes copying from a global database of pre-selected or targeted offers; user promotions that are edited, created, and/or updated by an individual user via the website; user promotions that are created by forwarding an email 170; and/or user promotions that are created by uploading a photo (generally image processing 160) of a promotion via the mobile app at 102.

When importing new promotions from an image 160 or email 170, attempts are made to extract keywords from either the email or the image's OCR text. Manually entered promotions rely on user-created data with some autocomplete assistance. The contents of the global database are imported directly from a marketing partner data store (e.g., to marketing database 185) and edited by the staff.

Promotions have a many:1 relationship with users.

### Tag

Promotions may be tagged by each user with 0-n unique tags. Each tag is represented with a string that is unique to the user. Tags have a many:1 relationship with a user and a many:many relationship with promotions.

### User

Each user has a unique user identifier in host site/server 60. Users may login with any email-based provider 170, including Google 171, MSN, Yahoo. They may also register their own account with host site 60 (generally). Each user account must have a unique email address. Each user will also have an optional basic profile including a discussion handle, information about their site behavior, privacy/sharing settings, an uploadable photo and a user description.

Metadata processing module 150 logs all user actions in metadata database 151 as separate events for metrics tracking. This enables website/server 60 to display a dashboard of user activity. Examples of user events may include creating a tag, updating their profile, adding a promotion to their wallet, and others.

### Image

An image stored by an embodiment server 60 is sometimes referred herein as “MSW”. All image data is stored in an Amazon S3 bucket 190 and the access URL is stored in the image table. Images have a many:1 relationship with a promotion.

### Email

The text and HTML content of the email 170 forwarded to MSW 60 by a user at client 50 can be stored in core database 140. Emails typically have a 1:1 relationship with promotions. Each promotion can have 0-1 attached emails.

### Profile

Each user profile can be stored at core database 140 and can include user specific data such as location, gender, shopping preferences and notification preferences. Each profile has a 1:1 relationship with a user.

### Metrics

Server 60 stores in data store 140 other metrics from a user. This can include specific aggregated activity metrics such as last visit, number of visits, and number of promotions. Each metric has a 1:1 relationship with a user.

### Events

Server 60 stores user specific events at metadata data store 151. For example, a specific event can be logged as well as event metadata and a timestamp. This is used to track detailed usage of various features. Events typically have a many:1 relationship with a user.

### Category

A category is a multi-level list of staff defined categories that can be used for promotions. A category can be used to help target advertising and to help users sort through one or more promotions. A category typically has a many:1 relationship with a promotion.

### Filter

A filter represents a user created promotion filter. The data is stored in data store 140. It can be used to store user-created store filters. Filters typically have a many:1 relationship with a user.

### Example II

Data Flow Components 100 is shown in FIG. 3.

A user client 101 (client 50 of FIG. 1) represents the common user interface. This interface may be implemented with a number of UI designs, including web 103, mobile web 102, mobile device or embedded widget. The user client 50, 101 communicates exclusively with a versioned web service interface 130.

Some features of the common user interface 101 include a login/register/logout of a user; browse interface for user's promotion data; and basic user profile management and password reset.

Additional optional features of the common user interface 101 can include sharing of promotional data with other users and social networking sites, an edit/create interface for new user promotions, an upload interface for images and attachments related to a user's promotions, support for autocompletion of manually entered promotions data, support for automated data entry from uploaded promotions; search of global and user promotional data, and suggested/sponsored promotions and advertisements.

A marketing client 120 (client 50 in FIG. 1) is an interface for maintaining trusted promotions and advertisements. Each advertiser user accesses any promotions or offers that he has submitted. Additionally, the marketing client 120, 50 enables administrative users to trigger processing scripts to collect/import offer information from established data sources 186. Marketing client 120 stores collected information at marketing database 185.

A web service API 130 is a versioned interface that allows the clients 50, 101, 102, 103, 120 to securely access, search and modify the core data.

A core database 140 stores all of the core data for the service. All access is via the web service 130. Data types stored include, for example, user login credentials, user promotional information, user profiles and sharing preferences, and state information for various processing tasks.

A metadata processing module 150 maintains a library 151 of valid store, product, category, and manufacturer/brand information. The module also maintains examples of user-entered promotional data in response to existing promotions as a tool for training the data processing engine. The library is used to turn human-readable promotion text into discrete metadata. Metadata fields include items such as product name, store/retailer name, manufacturer/brand name, valid or expiration dates and unique terms and conditions.

An image processing module 160 accepts a user-uploaded promotion image and can extract the following information: UPC or bar codes, text, and rotation or orientation of the promotion.

An email processing engine 170 monitors for emails sent to a pre-determined email address and attempts to extract relevant information from the email. The 2 main pieces of information extracted are the promotion/offer text (for processing by the metadata module) and any images (for processing by the image processing module).

An offer targeting module 180 is responsible for presenting and/or selecting offers and promotions that are relevant to a user. Both real-time and off-line algorithms are used to generate lists of promotions and offers that match a user's activity.

### Example III

A marketing module 200 is represented in FIG. 4 and is executed by host server 60. The marketing module 200 has two distinct users 210 and 220 and access to two different databases 250 (like 185 of FIG. 3) and 230 (like 140 of FIG. 3). Each user has a unique session.

The advertising user 210 has limited access to create, modify and view metrics related to the usage of their offers. The advertising user can also target their offers based on consumer user behavior and/or demographics. The advertising user has no access to web consumer user data except for aggregated metrics based on anonymous demographics.

The web consumer user 220 receives recommended offers and server 60/marketing module 200 responsively logs events such as clicks, redemptions, sharing actions and like/unlike. The events are logged as anonymous users with references to basic user demographic data. The web user shares a common session with the primary user database 230.

The advertising module 200 can present targeted or non-targeted promotions, offers and/or advertisements to consumer users. All offers or promotions use the same data schema, but may utilize of a few different revenue models. Some examples of possible revenue models are payment by click, commission sales, payment by presentation, payment for user referrals and other methods.

The targeting algorithm 240 integrates data gathered from use of the promotional management service. Consumer users volunteer geographic, age, gender and consumer purchasing behavior through a series of registration questions. Data is also gathered by monitoring or tracking user behavior (e.g., page views, clicks, sharing, uploads). This information can be used to present recommended offers that the user is interested in. By aggregating information on offers independently entered by the user, it is possible to target advertising offers with a high degree of granularity and similarity to the user's own preferences.

The marketing module 200 features a web based portal 290 to allow advertisers 210 to create, modify and track the usage of their offers. Each user has restricted access to their offers and anonymized user metrics related to the usage of their offers. Advertisers can view the click rates, redemption rates, impressions and other metrics for each offer. Advertisers can also view demographic and non-identifiable user information related to these activities. The data is presented to the user in the form of graphs and charts to help analyze trends. Advertisers may also specifically target their offers to specific users selected by age, location, gender, usage patterns and other criteria. Monitor the value of offers

Data is recorded on the usage of each offer. Users may click on an offer, add an offer to their personal wallet, like an offer or share an offer with others. Each of these actions is stored by the marketing module for use in analyzing the effectiveness of the targeting algorithm and the value of the offer to users. This data is used to empirically study the effectiveness of the targeting algorithms and to automatically refine the offers targeted to a user based on their behavior. The stored data can be aggregated by user specific information such as age, location, gender and other criteria to help increase both advertising revenue and the value of the offers to the user.

Another component of marketing module 200 is a user database 230. The user database 230 contains the session information 224 for mobile and web based users. Each user has a profile that contains certain demographic data such as their gender, age group, location, category preferences and other information. The demographic data is made available to the marketing module as anonymous keys and is used to improve the targeting algorithms. Advertising users can view only aggregated metrics based on user demographic data. The anonymization 223 and aggregation prevents any privacy concerns related to allowing advertisers to view and target their offers based on user demographics.

An offer database 250 contains session information for advertising users 210, aggregated metrics 280 based on the usage of offers and the offer data. Both advertising users 210 and daily asynchronous tasks add offers to the database 250. Advertising users 210 have restricted access to only the offers and metrics related to offers that they own.

The offer database 250 also contains local and global offers. Local offers comprise user-entered promotions, deals, etc. and can be followed and searched for by friends and family. The global offers comprise valid offers directly from affiliates, retailers, and local merchants. In sum, the offer database currently comprises over 500 affiliates, local merchants, retailers and established bloggers creating feeds, and user-entered data.

A targeting algorithm 240 features both static and dynamic elements. The static elements target offers based on demographics, aggregated user events (e.g., clicks, add events, likes, shares, adding to their wallet), user preferences and the targeting preferences set by advertising users. The dynamic elements monitor users' reaction to recommended offers and can modify the recommended offers. After each modification, user 220 acceptance is monitored over a limited period of time. If the modifications result in positive improvements, those modifications become a permanent part of the targeting for that user. Otherwise the improvements are discarded.

Automated asynchronous tasks run on a daily basis to import data from established data feeds 186. Examples of supported data feeds include RSS/XML, uploaded CSV files and custom web crawling scripts.

Aggregated Metrics 280 include an automated asynchronous task that runs on a daily basis to aggregate user events and demographics and stores the results indexed by each calendar day. This allows easy querying of demographic based metrics with a daily, weekly or monthly period.

The marketing module 200 can include a tracking API 221, targeting API 222, and an administration API 290 as shown in FIG. 4.

A RESTful HTTP/HTTPS API sets that follow the specification below. It can have access to cookie-based session information for both web and advertising users.

The advertising user 210 admin interface 290 is used to create, update and monitor offers. There are 2 different types of users: staff and 3rd party advertisers. Staff can have access to all offers and promotions and 3rd party advertisers can have access restricted to the offers and/or promotions they own.

Offers entered into the marketing module 200 are not displayed to users until they are moderated by a staff member. A staff member can activate a promotion by changing its state from pending to active, or can delete the promotion by changing its state from pending to deleted. Staff members may edit the promotion prior to distribution.

Staff may also create new user credentials for 3rd party advertisers and restrict their admin interface to a set list of promotion source values. Each promotion has a source value to indicate the source of the data. The promotion source is not displayed to web users.

Staff can also modify the targeting for specific users by querying anonymized users based on demographics and target offers specifically to those user groups. Staff may also see anonymized user specific metrics.

Advertisers 210 may use the admin interface to create, edit or delete offers. Advertisers cannot activate an offer for distribution and all changes must be moderated by a staff member.

Advertisers 210 may view aggregated metrics 280 for promotions, groups of promotions, or all promotions for a specific source. These metrics are collected on every calendar day and include the click, add to wallet/account, like and share behavior for users. Available demographics include the age, location, gender and activity level for the user.

### Web Service API v1

### Protocol

The API is built around RESTful and CRUD (create, read, update, delete) API principles. At the highest level all items are grouped into resources. Each resource has 2 general modes (list and detail) and 4 basic tasks (create, read, update and delete). The list mode refers to lists/groups of resources while the detail mode refers to a specific instance of a resource. Resources may be hierarchical and may have relationships with other resources.

### HTTP

At the HTTP level each task is specified with a custom HTTP and URL.

Create: HTTP POST to a list endpoint

Update: HTTP PUT to a detail endpoint

Read: HTTP GET to either a list OR detail endpoint

Delete: HTTP DELETE to a detail endpoint.

### URLs

The list and detail endpoint are differentiated by the URL format
List Endpoint: /api/_VERSION_/_RESOURCE_/_FORMAT_{—}
Detail Endpoint: /api/_VERSION_/_RESOURCE_/_ID_/_FORMAT_{—}
Supported Versions: v1, v1.1, v2, etc
Supported Formats: xml, json

### Filtering

Each list API also includes an integrated filter. The user or app can add custom parameters to the end of the URL to filter based on the fields contained in the resource.

### Common Searches

field_icontains=
field_gt/gte/lt/lte=
field=

### API Reference

### Promotion API

The promotion API is used to manage offers.

### URL

Detail: /api/_VERSION_/promotion/_ID_/_FORMAT_{—}
List: /api/_VERSION_/promotion/_FORMAT_{—}

### Security

A valid advertising session is required to use the create, update and delete
features. An API key is required to query offers.

### Read/Write Fields

brand: offer brand information (optional)
category: reference to a source specific category
code: redemption code for the offer
end_date: expiration date
start_date: valid date
identifier: identifier unique per each source
image: an upload filename,
image_url: a remote image URL
info: comments or info to display to the user
name: the display name
source: a MSW assigned source string,
offer: offer string
store: the store or source to display to the user
url: the redemption url

### Read Only Fields

available: the number of offers available, modifiable via admin only
date_created: creation date
date_modified: modification date
id: PK
like: like count
limited: boolean, yes if the offer has a limited availability, see available field,
modifiable via admin only

### Filter Parameters

search: a generic search term that queries multiple fields
category: a MSW website based category ID (not a source-specific category)
page: 1-based page number
custom: boolean. If true, displays offers targeted for the user only

### Tasks

Read
Targeted at either a list endpoint or a detail endpoint. The list endpoint displays summary information about all of the offers that match the query, the detail endpoint displays complete information about a specific offer
Update, Delete, Create
Targeted at a detail endpoint. Used to update/manage the promotions by an advertising user. Advertising users are restricted to modify only promotions with a source string that they are authorized to modify
Track
GET /api/_VERSION_/promotion/_ID_/track/
Logs a click of the promotion's URL.
Add
GET /api/_VERSION_/promotion/_ID_/add/Logs
an add to wallet action of the offer. Requires a valid web user session.
Like
GET /api/_VERSION_/promotion/_ID_/like/Toggles
the like preference for the user and updates the promotion's like count.
Requires a valid web user session.

### API Examples

Get offers targeted for a user

URL: /api/v1/promotion/?format=json
HTTP: GET
Parameters: custom=true
http://marketing.mysavvyway.com/api/v1/promotion/?format=json&custom=true
Response:
{
“meta”: {

“limit”: 20,
“next”: “/api/v1/promotion/?offset=20&limit=20&format=json”,
“offset”: 0,
“previous”: null,
“total_count”: 176

```
  },
  “objects”: [
  {
```

“available”: 1,
“brand”: “cesar”,
“category_id”: 110,
“code”: “”,
“date_created”: “2012-05-23T20:00:31”,
“date_modified”: “2012-08-26T21:00:23”,
“end_date”: “2012-12-31”,
“id”: 201,
“identifier”: “17341117”,
“image”: null,
“image_url”:

“http://cdn.promotions.com/insight.promotions.com/COS20/_Cache/_ImageCach
e/117/17341117.gif,

“info”: “”,
“like”: 1,
“limited”: false,
“name”: “$1.00 off Cesar Cookie Crunchies”,
“offer”: “$1.00 Off”,
“original_price”: “”,
“redeem”: “”,
“resource_uri”: “/api/v1/promotion/201/”,
“sale_price”: “”,
“source”: “promotions.com”,
“start_date”: “2012-05-15”,
“store”: “promotions.com”,
“url”:

“http://www.promotions.com/alink.asp?go=13903xh2010&bid=1249150001&pli
d=RSS&crid=RSS&cid=17341117&alt=yes”

},

### Example IV

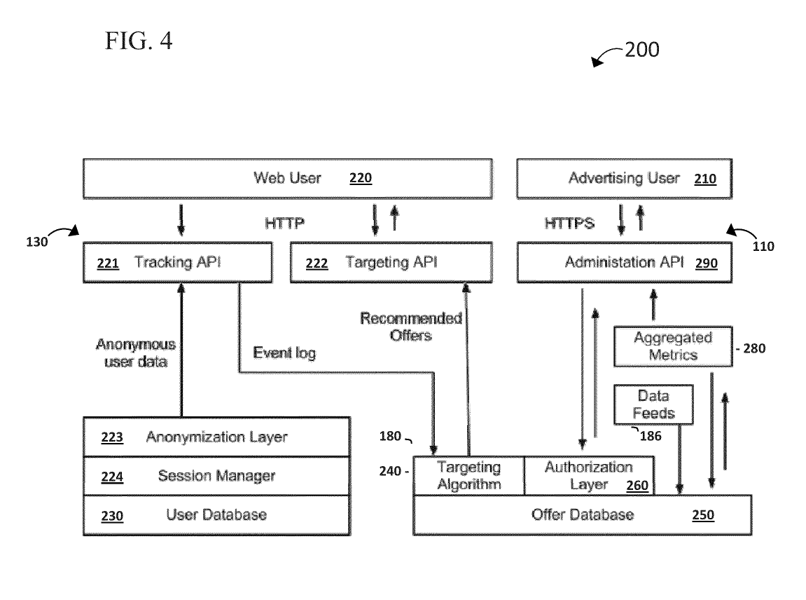

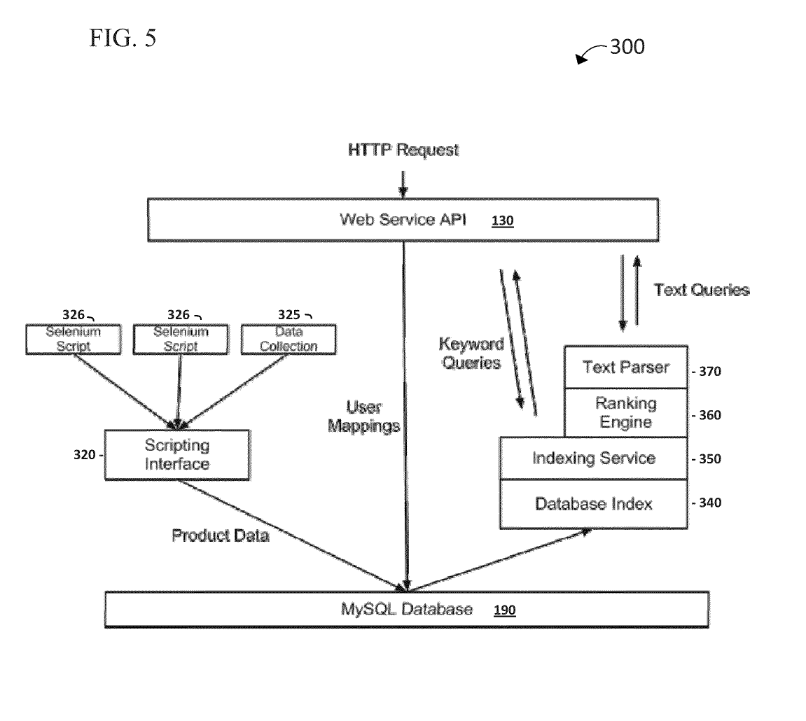

A metadata module 300 is shown in FIG. 5. The metadata module takes user-supplied data about a product and extracts key metadata fields such as the product name, manufacturer, description, and other information. Also, keyword extraction can handle input of unknown reliability, as well as learn from human correction of results, and maintain a database of established products. The input data can be captured from sources of unknown reliability. Match incomplete or possibly invalid data fields with a best guess approximation for the product metadata. Metadata results can be correctable by the user. The metadata engine can incorporate the user's corrections and use the results to improve the accuracy of the engine. A database of established, vetted, product metadata is maintained and collected by both automated and manual data entry. This information can be compared against raw data to create a best guess for the product information.

A module can run as a server available to clients and can feature scalability, independent development, and multiple clients.

The metadata engine will be scalable independently of other components based on current demand. It will have its own database, independent server and auto scaling tools as needed. The metadata engine also has the ability to develop without dependencies on other components. All information the module needs is either contained within the module's database, and can be accessed from Internet accessible databases or entered manually. The engine communicates with multiple clients using established APIs. Requires multithreaded server environment to be able to serve multiple clients simultaneously.

Clients communicate with the module via a web service API 130 layer. Clients will make different kinds of requests, such as known product metadata entered by a user (User Mappings), queries for metadata auto-completion (Keyword Queries), queries to extract keywords from raw text (Text Queries), and admin functionality (Relevancy Metrics, DB editing).

A scripting interface 320 imports known product data from established sources. The data collectors 325 are individually developed and can be enabled/disabled on demand. These fall into 2 general categories: web crawlers that automatically scan known sources for product information and data collectors that process imported data from known DB or file formats. The scripting interface provides a facility to run data collection scripts and also provides a common interface to input data into the database.

The database 190 contains information of 2 different types of metadata. The first is known product metadata from trusted sources. The second is a list of metadata pairs generated by a user from a given raw data string. This allows the engine to leverage common user input to improve the results. This database is only accessible from the metadata module.

An administration console can allow manual editing and administration of product data stored in the database. This will be powered by a django admin console connected to the database. A user can add, remove, and edit existing product information.

An indexing service 350 indexes the text strings in the database. This allows both fast searching for specific keywords and keyword extraction from promotion text.

A ranking engine 360 uses past information provided by users to alter the keyword extraction rankings providing by the indexing service. Past user entry of promotion metadata is stored in the database. This can improve relevancy of keyword extraction.

A text parser 370 parses promotion text strings from both images and emails. Extracts best-guess values for items like dates, titles, offers and terms by analyzing the text content, the layout of the text and the formatting (HTML email, etc).

### Web Service Protocol

The web service communicates using the HTTP protocol.

### Architecture

A django based web service can process the API and dispatch requests to the required data views. The API is designed to be RESTful and use the django tastypie 1.0 framework.

### Resources

### Product

This allows searching of established products in the database. Fields can include name, description, manufacturer, and UPC.

### Store

This allows searching of established store/retailer names in the database. Fields can include name, type, location, and Website URL.

### Manufacturer

This allows searching of established manufacturers in the database. Fields can include name and UPC-A Manufacturer ID.

### Commands

### Process

### Protocol: HTTP POST (or GET)

Parameters: A raw data string extracted from an offer or a promotion
Return Value: A json-encoded list of metadata from a matching product, or a best guess of metadata from the data if no matching product is found. This API generates a best guess set of metadata from a provided text string. Data is returned based on the following priority: Metadata matching known products in the database; Metadata matching user-supplied results to a similar input string; and Metadata based on looking for key words and phrases in the string.

### Suggestion

Protocol: HTTP POST

Parameters:
string—the original data string
data—a json-encoded set of product metadata

Return Value:
HTTP 201 if successfully added the suggestion
HTTP 400 with error status if data import is invalid

This creates a suggestion in the database based on a set of user supplied metadata for a specific raw import string. If the data import is invalid, an error is returned.

### Example URLs

| | |
|---|---|
| • | Searching for a product name |
| | Protocol: GET |
| | URL: |
| | http://tasks.mysavvyway.com/api/v1/product/?format=json&name_{——}icontains=Li |
| | fe |
| • | Listing all products |
| | Protocol: GET |
| | URL: http://tasks.mysavvyway.com/api/v1/store/?format=json |
| • | Retrieving a specific product |
| | Protocol: GET |
| | URL: http://tasks.mvsavvyway.com/api/v1/product/1/?format=json |
| • | Example Results: |
| | { |
| | “meta”: |

{
“limit”: 20,
“next”: “/api/v1/product/?offset=20&limit=20&format=json”,
“offset”: 0,
“previous”: null,
“total_count”: 6127
}, ”

objects”: [

{
“category”: [{

“id”: “3”,
“name”: “Activewear”,
“parent”: “/api/v1/category/2/”,
“resource_uri”: “/api/v1/category/3/”,
“source”: “”,
“source_metadata”: “”
}],

“code”: “”,
“description”: “Hanes - Boys Fleece Crew:, Hanes Fleece contains
EcoSmart \” polyester., Up to 5% polyester is made with recycled plastic
bottles to help reduce landfill., Style available as solid or with
screenprint., Hanes - Boys' Fleece Sweatpants:, Hanes Fleece contains
EcoSmart \” polyester., Up to 5% polyester is made with recycled plastic
bottles to help reduce landfill., Classic styling with elastic cuffs and side-
seam pockets.”,
“id”: “1”,
“manufacturer”: “”, “
name”: “Hanes - Boys Fleece Crew Sweatshirt and Sweat Pants Value
Bundle”,
“resource_uri”: “/api/v1/product/1/”,
“source”: “”,
“source_metadata”: “”,
“upc”: “”,
“url”: “”

},
{

“category”: [{

“id”: “3”,
“name”: “Activewear”,
“parent”: “/api/v1/category/2/”,
“resource_uri”: “/api/v1/category/3/”,
“source”: “”, “
source_metadata”: “”

}],
“code”: “”,
“description”: “Jacket:, Full zip front, Long sleeves, 2 side pockets,
Ribbed waistband and cuffs, , Pants:, Elastic waistband, 2 side pockets,
Side stripes”, “id”: “2”,
“manufacturer”: “Starter”,
“name”: “Starter - Boys' 2-Piece Track Set”,
“resource_uri”: “/api/v1/product/2/”,
“source”: “”,
“source_metadata”: “”,
“upc”: “0084763900300”,
“url”: “”

},

### Database

### Architecture

A MySQL database hosted on an Amazon RDS server. The database is automatically scalable and backups are created at routine intervals.

### Schema

### Product Model:

name: varchar(128), null=false
description: varchar(512), null=true
manufacturer: varchar(128), null=true
UPC: varchar(64), null=true

### Category Model:

name: varchar(32), null=false
parent: FK(category)

### Store Model:

name: varchar(128), null=false
type: varchar(64), null=true
scope: varchar(64), null=true
address: varchar(512), null=true
state: varchar(16), null=true
city: varchar(64), null=true
zip: varchar(16), null=true
url: varchar(256)

### Suggestion Model:

data: varchar(4092), null=False
   Raw data from the original offer/promotion
name: varchar(128), null=True
   User-supplied product name for the raw data
manufacturer: varchar(128), null=True
   User-supplied manufacturer for the raw data
category: varchar(128)
   User-supplied category ID for the raw data
store: varchar(128), null=True
   user-supplied store/retailer for the raw data
offer: varchar(128), null=True
   User-supplied offer for the raw data
terms: varchar(1024), null=True
   User-supplied terms

### Text Parser

### Filtering

Text parser filtering can prepare the raw import string into a standardized format to run through keyword extraction. Steps can include: standardizing all text to UTF-8 for processing, stripping out extra HTML that does not pertain to the content (e.g., <script>, <head>, <style> tags and other HTML that does not contain useful information), and removing un-readable, garbage, artifacts and not processable characters.

### Categorization

The categorization step looks for clues in the raw string that indicate metadata fields. This is highly custom and will be refined over time. Examples of text to identify can include recognizable dates in the text and key words around them (e.g., “expiration”, “valid”, etc), key terms that indicate section headings (e.g., “Terms and Conditions”, “Restrictions”, “Expiration”), and recognizable monetary terms (e.g., “XX.XX Off”, “Buy X Get X Free”).

### Layout Analysis

The layout analysis step looks for one or more clues in the geographic relationships between text elements and the formatting (if HTML) present. Some targets include the heading at the top of a promotion or text in bold/heading and the text at the bottom of a promotion or text in smaller print. Metadata extracted can include terms and conditions, valid date, expiration date, offer or value, product name, manufacturer or brand, and store and/or retailer.

Referring to FIG. 5, the text parser 370 can obtain sample promotion text from email or image based promotions (e.g., files of data, CSV File, Database rows), filtering text to UTF-8 and stripping out all XML/HTML, creating regular expressions to identify dates, and identify regular expressions of monetary offers. The text parser 370 can identify common formats such as: “Buy X Get X Free,” “Buy X Get $XX.XX Off,” “$XX.XX Off,” and “Save XXX,” where “X” represents a number, including zero. The text parser 370 can also determine keywords that are common in promotions. A function can be created to parse the text and identify the data likely associated with promotion terms and dates (e.g., expiration, valid). The text parser 370 can be an integrated text parser between an indexing service 350 and web service API 130. The corresponding fields into the data stream can include Offer/Value, Terms, Expiration Date, and Valid Date.

A ranking engine 360 can list matching suggestions built from an input text string from the index of the suggestion DB model. Also, a function that ranks keywords (e.g., Product, Store, and Manufacturer) found in suggestions can be created by reliability. The best reliability thresholds can be used to modify ranking data (e.g., Product, Store, and Manufacturer) from the indexing service based on existing promotion data. The ranking engine 360 can be integrated into data flow between indexing service and web service API. The ranking of the items (e.g., Store/Retailer Name, Product Name, Manufacturer/Brand Name) can be modified in the data feed from the indexing service.

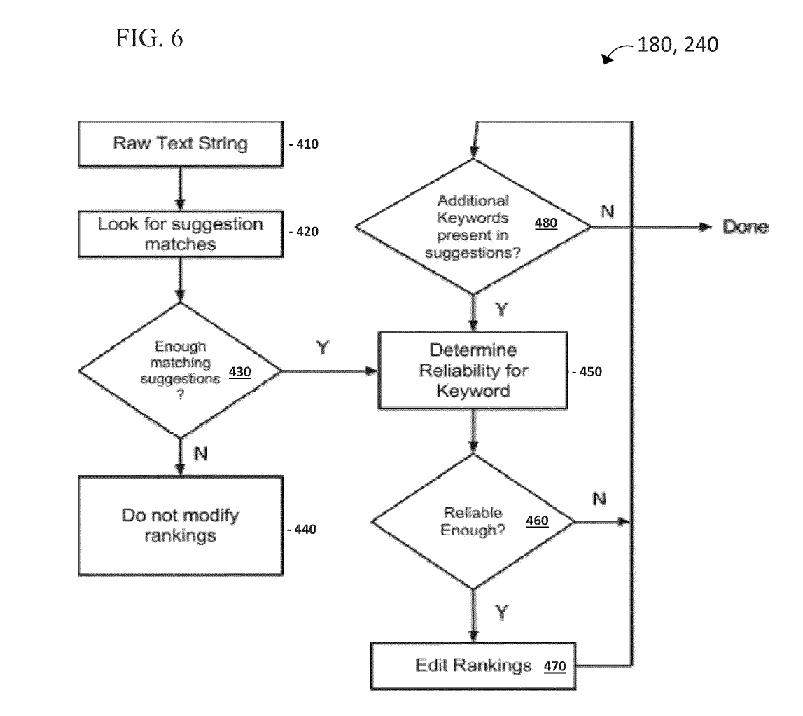

FIG. 6 shows a flowchart of the ranking engine 180, 240. The ranking engine 180, 240 accepts the results of keyword extraction by the indexing service, and re-ranks them based on user entered data. Every promotion that is parsed(images, email) has a raw text string. Users enter their own metadata for common fields such as product name, store name and manufacturer. At regular intervals, the information a user has entered for a given promotion text string is stored in the database as a suggestion. This information can be used to improve the relevancy of keyword extraction.

Matching data 420 identifies suggestions in the database that are similar to the input text string 410. Multiple promotions often have similar text content. Once these suggestions are identified, they can be analyzed for potential keywords.

A suggestion analysis 430 takes a list of matching suggestions and analyzes them for reliability. If a given piece of metadata occurs once in a small set of suggestions, this is considered low reliability. If a piece of metadata occurs approximately 80% of the time in a large set of suggestions, this is considered high reliability. The goal is to build a list of keywords sorted by their reliability based upon the user suggestions.

The rankings are imported from the indexing service. These results can be modified by keywords that are found in the user suggestions. If a high-reliability piece of metadata is found in the user suggestions, and its ranking is low in the data provided by the indexing service, the ranking is increased.

### Example V

A goal of keyword extraction is to take user-supplied data about a product and to extract key metadata fields such as the product name, manufacturer, description, and other information. The keyword extraction can handle input of unknown reliability, learn from human correction of results, and maintain a database of established products. The input data is captured from sources of unknown reliability. Incomplete or possibly invalid data fields can be matched with a best guess approximation for the product metadata. Metadata results can be correctable by the user. The engine can incorporate the user's corrections and use the results to improve the accuracy of the engine. A database of established, vetted, product metadata can be maintained and collected by both automated and manual data entry. This information is compared against raw data to create a best guess for the product information.

Referring to FIG. 5, text parser 370 can parse promotion text strings from both promotion images and emails. The text parser can extract a best-guess value for items (e.g., dates, titles, offers and terms) by analyzing the text content, the layout of the text and the formatting (e.g., HTML, RTF, email). The text parser 370 does not necessarily behave as an OCR or image parsing element.

A goal of filtering is to prepare the raw import string into a standardized format to run through keyword extraction. Steps in filtering can include:

standardization of text to UTF-8 for processing; stripping out extra HTML that does not pertain to the content (e.g., <script>, <head>, <style> tags and other HTML that does not contain useful information); and removing un-readable, garbage, artifacts and not processable characters.

A categorization step looks for clues in the raw string that indicate metadata fields. This is highly customized and will be refined over time. Examples of text to identify include dates in the text and key words around them (e.g., “expiration,” “valid”). Other examples include key terms that indicate section headings such as “Terms and Conditions,” “Restrictions,” and “Expiration.” Also, recognizable monetary terms such as “$XX.XX Off”, “Buy X Get X Free” can be identified, where “X” represents a number or zero.

A layout analysis step looks for clue in the geographic relationships between text elements, and the formatting (e.g., if HTML) present. Some initial targets are heading at the top of a promotion or text in bold/heading tags and text at the bottom of a promotion or text in smaller print.

Metadata extracted from text can include the terms and conditions, valid date, expiration date, and offer or value of the promotion.

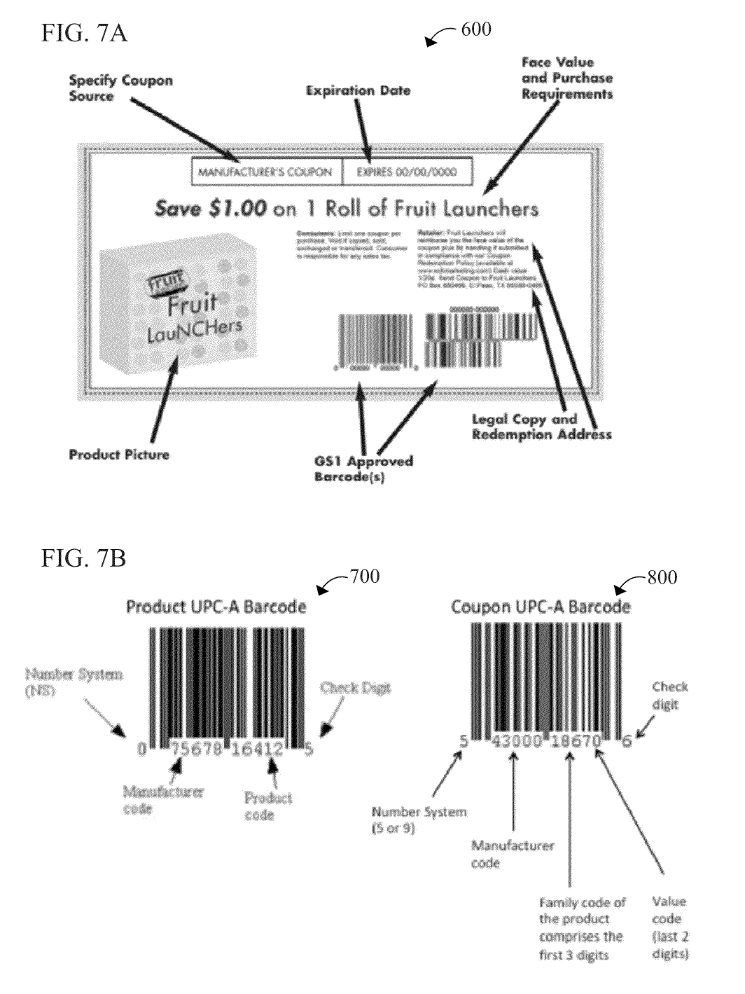

An example of a standard Manufacturer's coupon 600 is shown in FIG. 7A. As shown in FIG. 7A, different information can be provided on a coupon, such as coupon source, expiration date, face value, purchase requirements, picture of product, one or more barcodes, and legal copy and redemption address.

An example of a Manufacturer's Product 700 and Coupon 800 barcode are shown in FIG. 7B. As shown in FIG. 7B, information typically provided on a barcode can include a number system, manufacturer code, product code, family code, value code, and check digit.

### Example VI

One task of the web service API 130 in FIG. 5 includes the ability to provide a versioned interface to support multiple client versions and updates to the data schema and APIs. Another task of the web service API is to reduce dependencies between components by providing a common interface for component-component communication. Another task of the web service API is to allow multiple security levels for customized data access based on the needs of the client. By combining these tasks, QA can be streamlined and dependencies between components under parallel development can be limited. The minimal set of web services covers a few different tasks that are outlined in the following sections.

The API is built around RESTful and CRUD (“create, read, update, delete”) API principles. At the highest level all items are grouped into resources. Each resource has 2 general modes (list and detail) and 4 basic tasks (create, read, update and delete). The list mode refers to lists/groups of resources while the detail mode refers to a specific instance of a resource. Resources may be hierarchical and may have relationships with other resources.

### HTTP

At the HTTP level each task is specified with a custom HTTP and URL.

Create: HTTP POST to a list endpoint

Update: HTTP PUT to a detail endpoint

Read: HTTP GET to either a list OR detail endpoint

Delete: HTTP DELETE to a detail endpoint.

### URLs

The list and detail endpoint are differentiated by the URL format
List Endpoint: /api/_VERSION_/_RESOURCE_/_FORMAT_{—}
Detail Endpoint: /api/_VERSION_/_RESOURCE_/_ID_/_FORMAT_{—}
Supported Versions: v1, v1.1, v2, etc
Supported Resources: user, coupon, list, catalog, product
Supported ID: ID for the resource
Supported Formats: xml, json

### Security

The API supports 2 different security models:
Shared secret that is distributed to each API user
User authentication via a cookie after entering a username/password combination

### Filtering

Each list API also includes an integrated filter. The user or app can add custom parameters to the end of the URL to filter based on the fields contained in the resource.

### Common Searches

field_icontains=
field_gt/gte/lt/lte=
field=

### API Reference

### Coupon API

The list API is used to manage coupons that are specific to a user. Only coupons belonging to the user or to an authorized feed are displayed.

### URL

Detail: /api/_VERSION_/coupon/_ID_/_FORMAT_{—}
List: /api/_VERSION_/coupon/_FORMAT_{—}

### Security

A valid user session is required to use this API

### Read/Write Fields

name: coupon name
code: coupon code, if UPC-A—auto sets the offer field
comments: user comments
category: the category resource for a coupon
end_date: expiration date
processing: boolean, if true coupon fields are undetermined
link: shop URL
store: store name
offer: offer string
state: used to move coupons to/from the trash
coupontags: tags for a coupon
public: boolean to indicate visibility to followers
start_date: the valid date for the coupon
type: string for the type, currently set to “coupons”
favorite: boolean
product: string for the product/brand

### Read Only Fields

user: the user that owns the coupon
source: internal code for the origin of the data
guid: UUID unique identifier for the coupon
image: an array of image info
email: resource ID for an attached email
id: unique PK

### Other Parameters

friend: the ID for the feed's owner. Required for access to a feed's coupons
global_term: a search string to search the offer, name, store, comments and product field

### Tasks

### Read

Targeted at either a list endpoint or a detail endpoint. The list endpoint displays summary information about all of the user's coupons, the detail endpoint displays complete information about a specific user coupon

### Update, Delete, Create

Targeted at a detail endpoint. Used to update/manage the coupons by the user
Upload image
POST /api/_VERSION_/coupon/_ID_/upload/
Uploads a single image file and attaches it to the coupon

### Parameters:

files[ ]: Uploads the jpg/gif/png file attached to the “files[ ]” POST parameter

### Email Coupons

POST /api/_VERSION_/coupon/email/
Emails the specified coupons to an email address

### Parameters:

coupons: an array of coupon IDs to email
friend: if emailing from a feed, the id of the coupon's owner
email: the ‘to’ email address
message: the body of the email

### Copy Coupon

POST /api/_VERSION_/coupon/_ID_/copy/
Copies a coupon and its images from a feed to the user's wallet

### User API

The user API is used to read detailed user information and to update a user's profile.

### URL

Detail: /api/_VERSION_/user/_ID_/_FORMAT_{—}
Login: /api/_VERSION_/user/login
Register: /api/_VERSION_/user/register
The_ID_field matches the username for the user

### Security

A valid user session is require to read, update or delete. An API key is required to create users.

### Read Only Fields

username: the email address for the user
email: the email address for the user
date_joined: the join date for the user
last_login: the last login date for the user
id: the ID for the user object
is_active: indicates if the user has fully registered
emails: list of alternate emails
filters: list of store filters
metrics: resource URI for the user's metrics
profile: in-line list of profile fields, refer to these by field name when updating
profile.state: auto-set by zipcode
profile.city: auto-set by zipcode
profile.shared_users: list of email addresses with access to public coupons
profile.friends: feeds the user is following
   Read/Write Fields (on update refer to profile files as independent fields)
first_name: the user's full name
gender: M or F
birthday: date field
info: boolean, preference to receive newsletters
expires: boolean, preference for expiration notifications
summary: boolean, preference for summary notifications
suggested: boolean, preference for suggestions notifications
shared: boolean, preference for sharing notifications
changes: boolean, preference for profile change notifications
frequency: period in days of periodic notifications
trash_sweep: time in days to empty the trash
trash_timer: boolean, preference to automatically move 60-day old coupons
without expiration dates to the trash
coupon_sweep: time in days to wait before moving expired coupons to the trash
onboard: boolean, onboarding process completed
age: integer representing the user's age group
zipcode: 6 digit US/CN zipcode. Auto-sets the city/state
favorites: list of resource URIs for the user's favorite categories

### Additional Update Parameters:

add_email: a single email address to add as an alternate email
remove_email: a single email address to remove as an alternate email
add_friends: a list of email addresses to allow access to user's shared coupons
remove_friend: a single email address to remove access to user's shared coupons
old_password: the old password when changing a password
new_password: the new password when changing a password

### Tasks

Read: Displays information about the current user, the detail endpoint displays extended
information
Update: Allows a user to update their information
Image API: The image API is used to get information about a coupon image

### URL

Detail: /api/_VERSION_/image/_ID_/_FORMAT_{—}
   Security: A valid user session is required to use this API

### Read Only Fields

coupon: the coupon that owns the image
id: unique PK
date_modified: last modification date
date_created: last creation date
thumbnail: name of the thumbnail image
thumbnail url: URL of the thumbnail image
name: file name of the image
name_url: URL of the image

### Tasks

Read: Targeted at a detail endpoint. The list endpoint is not used.
Delete: Targeted at a detail endpoint. Used to delete an image.
Rotate image
POST /api/_VERSION_/image/_ID_/rotate/
Rotates the image and its thumbnail 90 degrees
CouponTag API: The coupontag API is used to get information about a user's coupon tags

### URL

List: /api/_VERSION_/coupontag/_FORMAT_{—}
Detail: /api/_VERSION_/coupontag/_ID_/_FORMAT_{—}
   Security: A valid user session is required to use this API

### Read Only Fields

count: the number of attached coupons
id: the PK for the row
user: the user that owns this tag
   Read/Write Fields: name: the name of the tag

### Tasks

Read: Targeted at a detail or a list endpoint
Create: Targeted at a list endpoint to create a new coupon tag
Delete/Update: Targeted at a detail endpoint to delete or update the associated coupons
UserFilter API: The userfilter API is used to manage custom coupon filters

### URL

List: /api/_VERSION_/userfilter/_FORMAT_{—}
Detail: /api/_VERSION_/userfilter/_ID_/_FORMAT_{—}
   Security: A valid user session is required to use this API

### Read Only Fields

id: the PK for the row
date_modified: the last modified date
date_created: the creation date
user: the user that owns the coupon

### Read/Write Fields:

name: the display name of the filter
   filter_string: the API query for the filter
   info: a description of the filter

### Tasks

Read: Targeted at a detail or a list endpoint
Create: Targeted at a list endpoint to create a new filter
Delete: Targeted at a detail endpoint to delete the filter

### Email API

The email API is used to get the details of an email attached to a coupon

### URL

Detail: /api/_VERSION_/email/_ID_/_FORMAT_{—}

### Security

A valid user session is required to use this API

### Read Only Fields

id: the PK for the row
date_modified: the last modified date
date_created: the creation date
coupon: the coupon that owns the email
html: the HTML content of the email
text: text text content of the email
sender: the from email
subject: the subject of the email

### Tasks

Read: Targeted at a detail or a list endpoint
CouponCategory API: The couponcategroy API is used to get a list of all coupon
categories

### URL

detail: /api/_VERSION_/couponcategory/_ID_/_FORMAT_{—}
list: /api/_VERSION_/couponcategory/_FORMAT_{—}
   Security: A valid API key is required to access this resource

### Read Only Fields

id: the PK for the row
name: the display name for the category
parent: the parent category resource, or null if none
children: a list of the child categories, or empty list if none

### Tasks

Read: Targeted at a detail or a list endpoint
Offer API: The couponcategroy API is used to get a list of all staff created offer strings

### URL

list: /api/_VERSION_/offer/_FORMAT_{—}
   Security: A valid API key is required to access this resource

### Read Only Fields

id: the PK for the row
name: the display name for the offer
type: the type selector for the code
code: a unique code that matches the type

### Tasks

Read: Targeted at a list endpoint

### Examples for API

Register a new user

URL: /api/v1/register/
HTTP: POST
Header: content-type = application/json
Data: {“username”:”testuser@test.com”,

```
  “password”:”myvette”, “first_name”:”John Cru”}
  https:/ws.mysavvyway.com/api/v1/user/
```

Response:

HTTP 201 if successful, 40X or 500 otherwise.

```
  Get the user's info
  URL: /api/v1/user/?format=json
```

HTTP: GET

https://ws.mysavvyway.com/api/v1/user/?format=json

Response:

″meta″: {

″limit″: 20,
″next″: null,
″offset″: 0,
″previous″: null,

```
    ″total_count″: 1
  },
  ″objects″: [
    {
```

″date_joined″: ″2012-08-02T07:57:20″,
″email″: ″jackfrost@hoo.com″,
″resource_uri″: ″/api/v1/user/100000009/″,
″username″: ″jackfrost@hoo.com″,
″first_name″: ″John Denver″,
″id″: 100000009,
″is_active″: true,
″last_login″: ″2012-08-23T22:47:58″,
″metrics″: ″/api/v1/usermetrics/8/″,
″emails″: [

{

″address″: ″poopoo@poo.com″,
″date_created″: ″2012-08-24T00:35:54″,
″date_modified″: ″2012-08-24T00:35:54″,
″id″: ″27″,
″resource_uri″: ″/api/v1/useremail/27/″,
″user″: ″/api/v1/user/100000009/″

}

],
″filters″: [
{

″date_created″: ″2012-08-24T00:14:59″,
″date_modified″: ″2012-08-24T00:14:59″,
″filter_string″: ″store_{——}icontains:walgreens″,
″id″: 22,
″info″: ″″,
″name″: ″walgreens″,
″resource_uri″: ″/api/v1/userfilter/22/″,
″user″: ″/api/v1/user/100000009/″

```
  }
],
″profile″: {
  ″age″: 1,
  ″birthday″: ″2012-08-07″,
  ″changes″: true,
  ″city″: ″BOSTON″,
  ″coupon_sweep″: 1,
  ″date_created″: ″2012-08-02T07:57:20″,
  ″date_modified″: ″2012-08-21T15:01:09″,
  ″deals″: false,
  ″description″: ″″,
  ″expert″: true,
  ″expires″: true,
  ″favorites″: [
```

″/api/v1/couponcategory/68/″,
″/api/v1/couponcategory/74/″,
″/api/v1/couponcategory/112/″

```
  ],
  ″frequency″: 1,
  ″friends″: [
```

```
{
  ″email″: ″info@mysavvyway.com″,
  ″first_name″: ″happy and you know it″,
  ″id″: 100000010,
  ″last_coupon″: ″test″,
  ″last_name″: ″″,
  ″last_seen″: ″2012-08-15T15:40:16″
}
```

```
  ],
  ″gender″: ″F″,
  ″id″: ″8″,
  ″image″: ″″,
  ″info″: true,
  ″onboard″: false,
  ″resource_uri″: ″″,
  ″shared″: true,
  ″shared_users″: [
```

″admin@mysavvyway.com″,
″paul.watson@gmail.com″

```
  ],
  ″state″: ″MA″,
  ″suggested″: true,
  ″summary″: false,
  ″trash_sweep″: 7,
  ″trash_timer″: true,
  ″usage″: 1,
  ″user″: ″/api/v1/user/100000009/″,
  ″zipcode″: ″01916″
```

```
    },
  }
  ]
}
```

Get a List of all Coupons with Search Criteria

URL: /api/v1/coupon/?format=json

HTTP: GET

https://ws.mysavvyway.com/api/v1/coupon/?format=json&name_contains=shirt
Response:
{
″meta″: {″limit″: 20, ″next″: null, ″offset″: 0, ″previous″: null, ″total_count″: 3},
″objects″: [
{
“name”:”Buy 1 get 2 Free Orange T-Shirt”
″resource_uri″: ″/api/v1/catalog/22/″
},
...
...
]
}

### Get Full Info for a Specific Catalog Coupon

URL: /api/v1/coupon/_{——}COUPON_ID_{——}/?format=json

HTTP: GET

https:/ws.mysavvyway.com/api/v1/coupon/22/?format=json

Response:

{
“category”: {

“children”: [ ],
“id”: “49”,
“name”: “Apparel, Shoes & Accessories”,
“parent”: null,
“resource_uri”: “/api/v1/couponcategory/49/”

```
  },
  “code”: “2345654356”,
  “comments”: “What a wondefrul deal!”,
  “coupontags”: [
```

“/api/v1/coupontag/123/”,
“/api/v1/coupontag/124/”,
“/api/v1/coupontag/133/”,
“/api/v1/coupontag/23/”

```
  ],
  “date_created”: “2012-08-06T10:12:20”,
  “date_modified”: “2012-08-15T03:08:38”,
  “email”: [ ],
  “end_date”: “2012-09-06”,
  “guid”: “1e02c366-dfd9-11e1-9a75-12313b046c3e”,
  “id”: 21,
  “image”: [
```

```
{
  “coupon”: “/api/v1/coupon/21/”,
  “date_created”: “2012-08-06T10:12:20”,
  “date_modified”: “2012-08-06T10:12:20”,
```

“id”: 15,
“metadata”: “”,
“name”: “”,
“processing”: false,
“resource_uri”: “/api/v1/image/15/”,
“text”: “”,
“thumbnail”: “”,
“thumbnail_url”:
“http://www.awltovhc.com/image-5751995-10915901”,
“upc”: “”,
“url”: “”,
“user_name”: “”

}
],
“link”: “http://www.tkqlhce.com/click-5751995-10915901”,
“name”: “Summer Sale 40% off”,
“offer”: “”,
“processing”: false,
“public”: false,
“resource_uri”: “/api/v1/coupon/21/”,
“state”: 1,
“store”: “cj”,
“type”: “coupons”,
“used”: false,
“user”: “/api/v1/user/100000009/”

}

### Create a User Specific Coupon

URL: /api/v1/coupon/?format=json

HTTP: POST

https://ws.mysavvyway.com/api/v1/coupon/?format=json

Header: content-type = application/json

Data:
{
″name″: ″Free willy and pauline today!”,

“category”:”/api/v1/couponcategory/20/”,
“store”:”A whale of a time”,
“offer”:”2 orcas for the price of one”,
“comments”:”What about the salmon?”
“end_date”:″2012-12-01″,
“public”:false,
}
Response: HTTP 201

### Edit the Name of a User Specific Coupon

URL: /api/v1/coupon/_{——}COUPON_ID_{——}/?format=json

HTTP: PUT

https://ws.mysavvyway.com/api/v1/coupon/22/?format=json

Header: content-type = application/json
Data: {“name”:“Get 2 shirts for the price of 1” }
Response: HTTP 204

### Example VII

### Web Service Server Specification

### Configuration

### Software Installation

Ubuntu 11.04 naty base image community EBS: ami-06ad526 f
apt-get update (apt-get update)
git 1.7.4.1-3 (apt-get install git)
Deployment key attached from github.com
apache2 2.2.17 (apt-get install apache2)
libapache2-mod-python (apt-get install libapache2-mod-python)
python-mysqldb (apt-get install python-mysqldb)
python-django 1.2.5 (apt-get install python-django)
libapache2-mod-wsgi (apt-get install libapache2-mod-wsgi)
python-setuptools (apt-get install python-setuptools)
python-pip (apt-get install python-pip)

### Apache/Django Configuration

WSGI Config (/var/www/django.wsgi)

import os
import sys
path = ‘/workarea/core’
if path not in sys.path:

sys.path.insert(0, ‘/workarea/core’)

os.environ[‘DJANGO_SETTINGS_MODULE’] = ‘webservices.settings’
import django.core.handlers.wsgi
application = django.core.handlers.wsgi.WSGIHandler( )

Apache2 Config(/etc/apache2/sites-available/default-ssl)

<IfModule mod_ssl.c>
<VirtualHost _default_:443>

ServerAdmin admin@mysavvyway.com
ServerName dev.ws.mysavvyway.com
DocumentRoot /var/www
<Directory /var/www/>

Order allow,deny
allow from all

</Directory>
WSGIScriptAlias / /var/www/django.wsgi
ErrorLog ${APACHE_LOG_DIR}/error.log
# Possible values include: debug, info, notice, warn, error, crit,
# alert, emerg.
LogLevel warn
CustomLog ${APACHE_LOG_DIR}/ssl_access.log combined
# SSL Engine Switch:
# Enable/Disable SSL for this virtual host.
SSLEngine on
# A self-signed (snakeoil) certificate can be created by installing
# the ssl-cert package. See
# /usr/share/doc/apache2.2-common/README.Debian.gz for
more info.
# If both key and certificate are stored in the same file, only the
# SSLCertificateFile directive is needed.
SSLCertificateFile /workarea/keys/dev.ws.mysavvyway.com.pem
SSLCertificateKeyFile /workarea/keys/dev.ws.mysavvyway.com.key
</VirtualHost>

</IfModule>

### Configure Django

1. Start the webservices project (django-admin startproject webservices)
2. Start the API app (python admin.py startapp api)
3. Start the metrics app (python admin.py startapp metrics)
4. Install tastypie (pip install django-tastypie)
5. Install django-analytics (https://github.com/praekelt/django-analytics/tarball/v0.0.1)
6. Install django-social-auth
7. Install django-registration

### Django Settings

The settings are contained in 2 files, settings.py and setttings local.py. The local settings contain the variable parameters. These parameters differ between the dev and the production server environment. Examples of variable parameters include: database settings, debug settings, logging files and levels, and security parameters.

### Security

All access to the servers is controlled by SSH keys. The development and production servers will have different SSH keys. The default user is ubuntu.

Development Server (dev.ws.mysavvyway.com)

The development server exposes ports 22, 80 and 443 to the world for use during development. The server has access to only the dev code DB and dev s3 repositories to prevent any inadvertent disruption of the production environment. The ssl certificate is installed on the dev server.

Production Server (ws.mysavvyway.com)

The production servers expose port 22 to the world, and port 80 to their specific load balancer. All access must be made via port 443 to the load balancer. The SSL certificate is installed on the load balancer.

### Administration

### Admin Console

The basic core parameters may be accessed via the admin console. The admin console is located at https://dev.ws.mysavvyway.com/admin or https://ws.mysavvyway.com/admin. All of the basic DB tables may be edited through here.

### MySQL DB Access

The web services servers use the core DB. The core DB is hosted via an Amazon RDS instance in the AWS cloud.

Access to the MySQL core database is provided via SSH and a valid username/pw. All users must first ssh into a cloud server with DB access, then connect to the specific MySQL endpoint using a valid username and password combination,

The web service servers have full read and write access to their tables in the core DB.

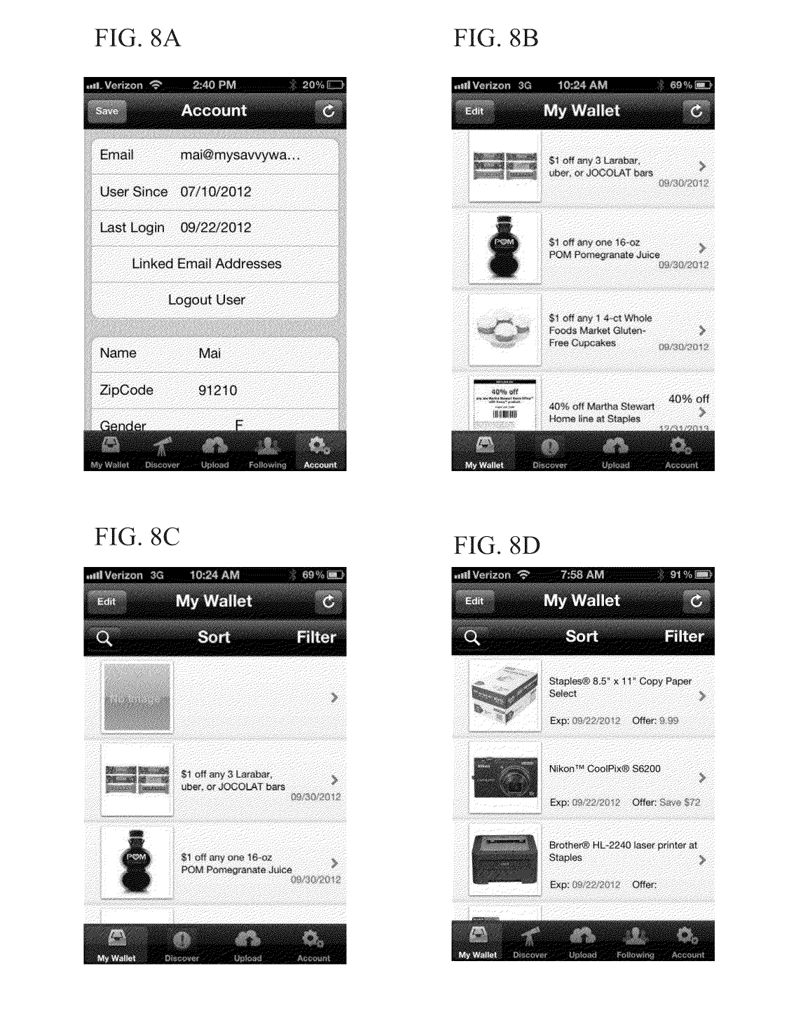

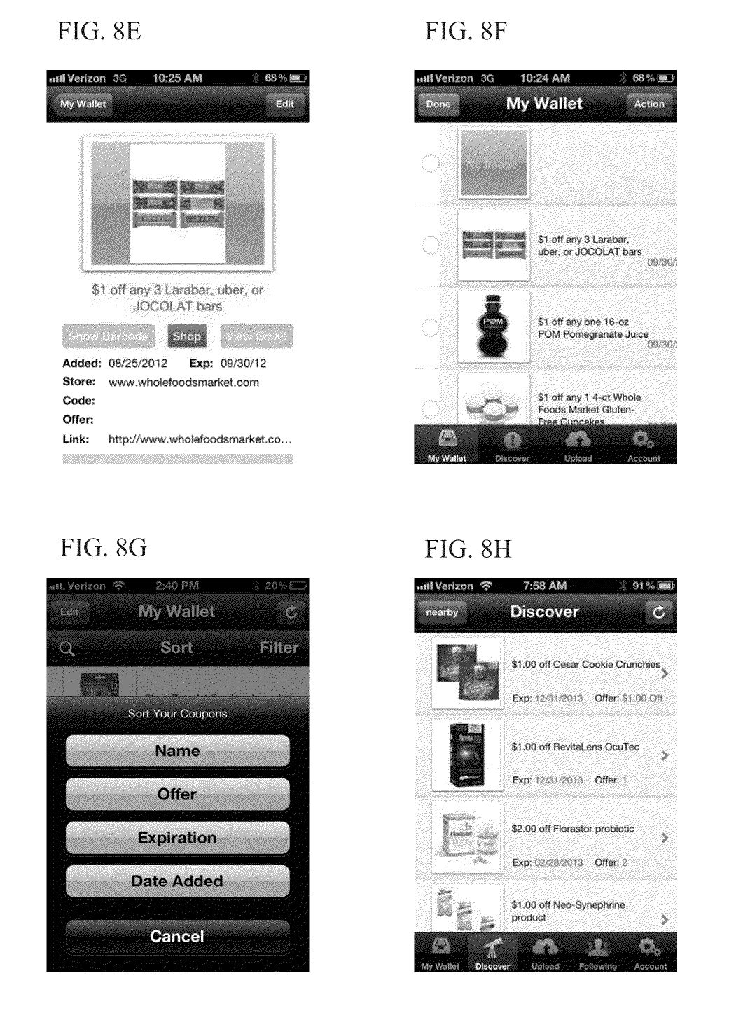

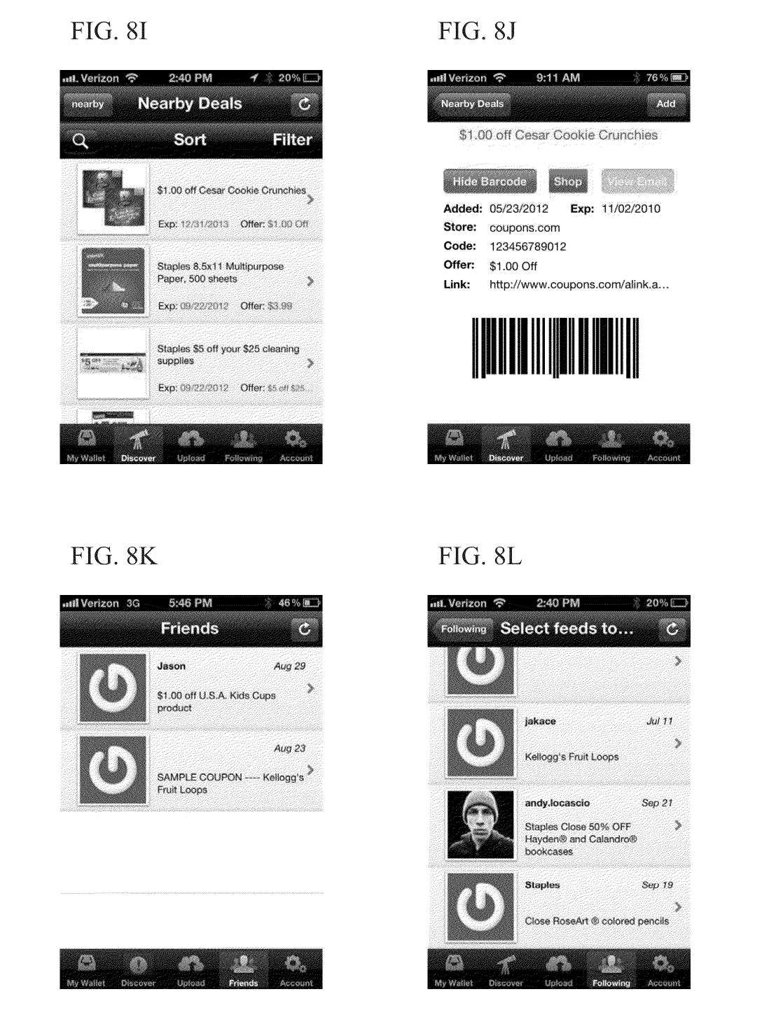

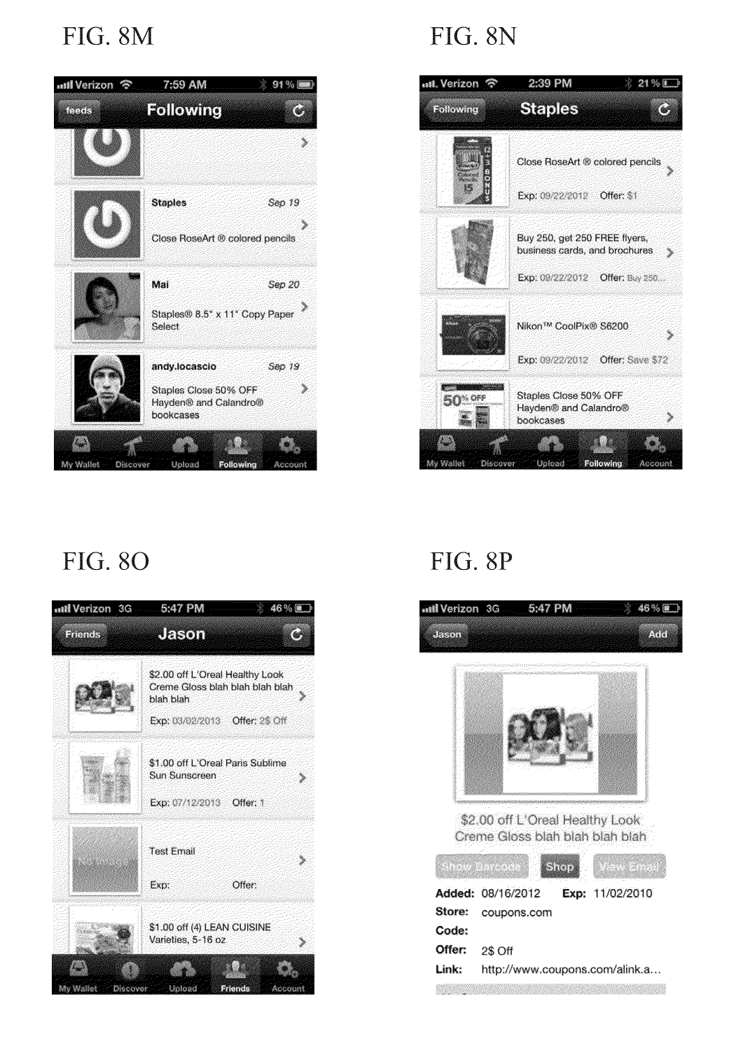

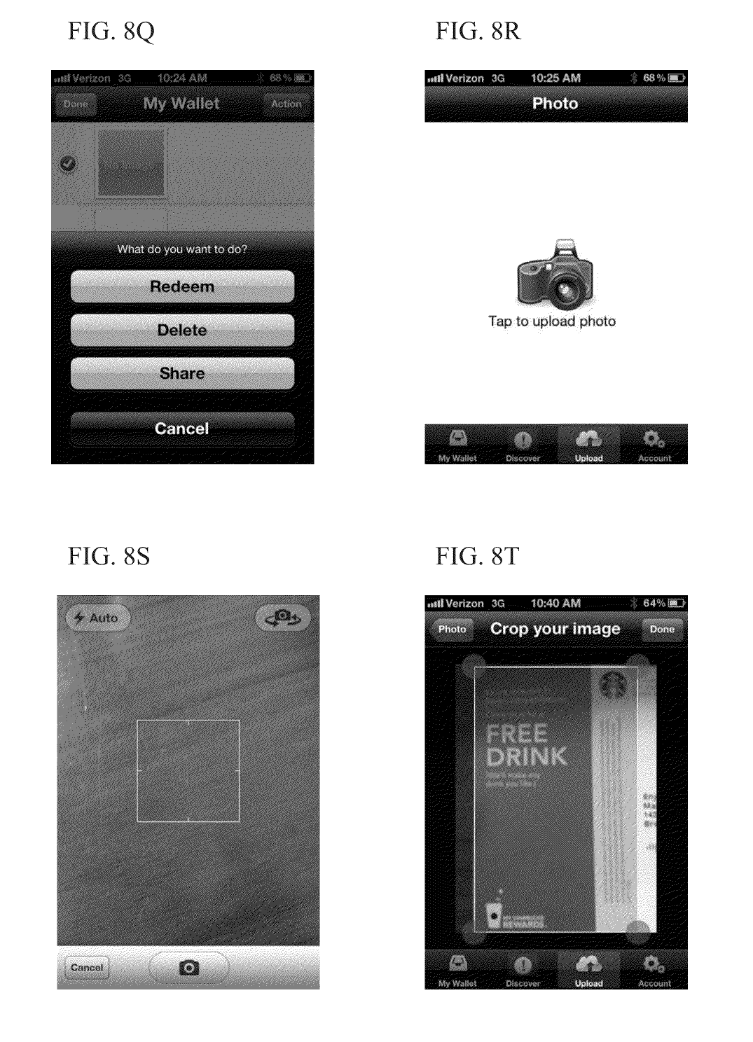

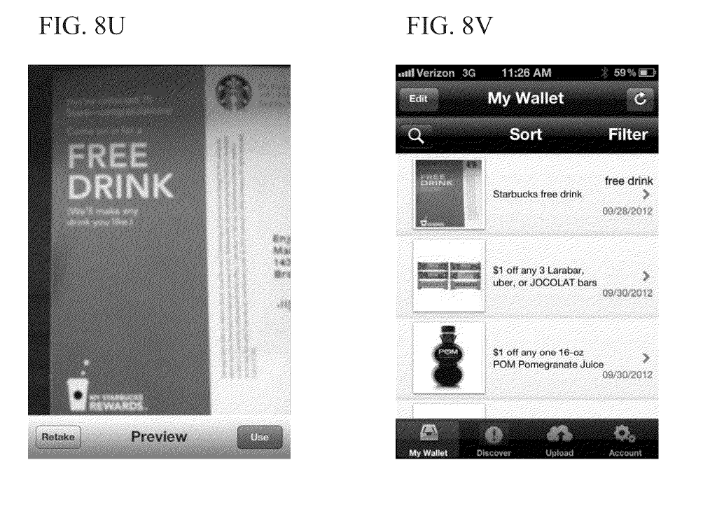

FIGS. 8A-8V show one embodiment of the present invention on a mobile device running iOS.

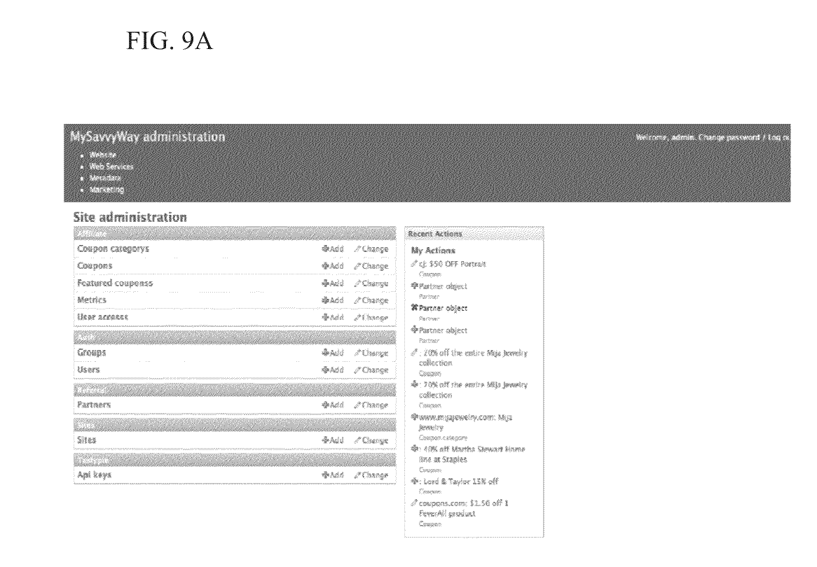

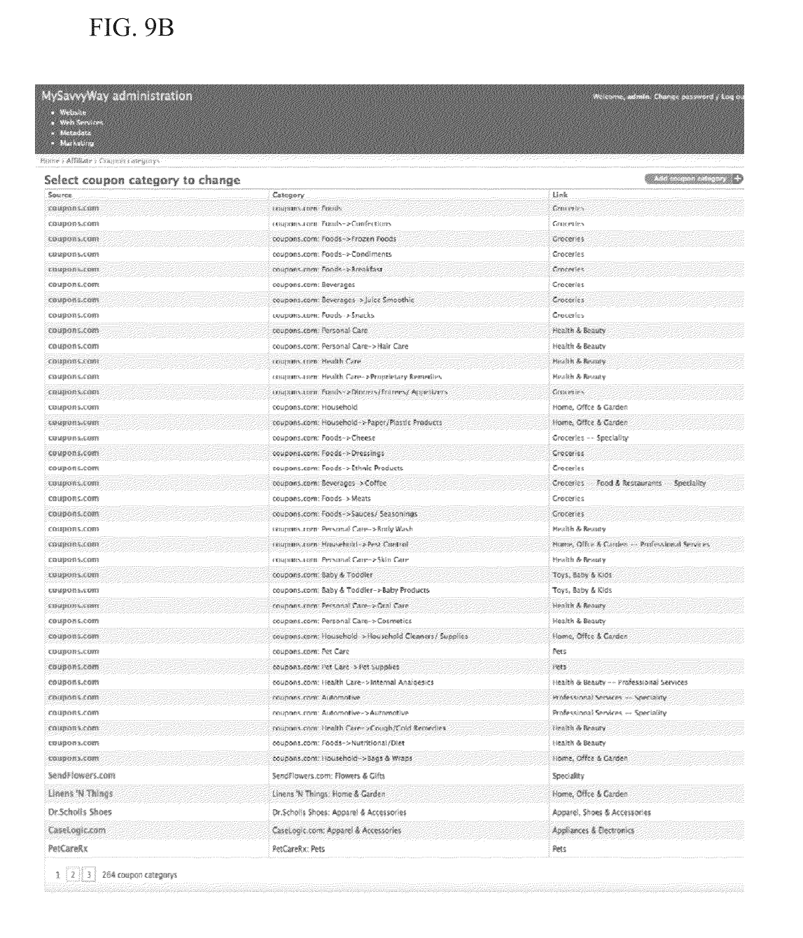

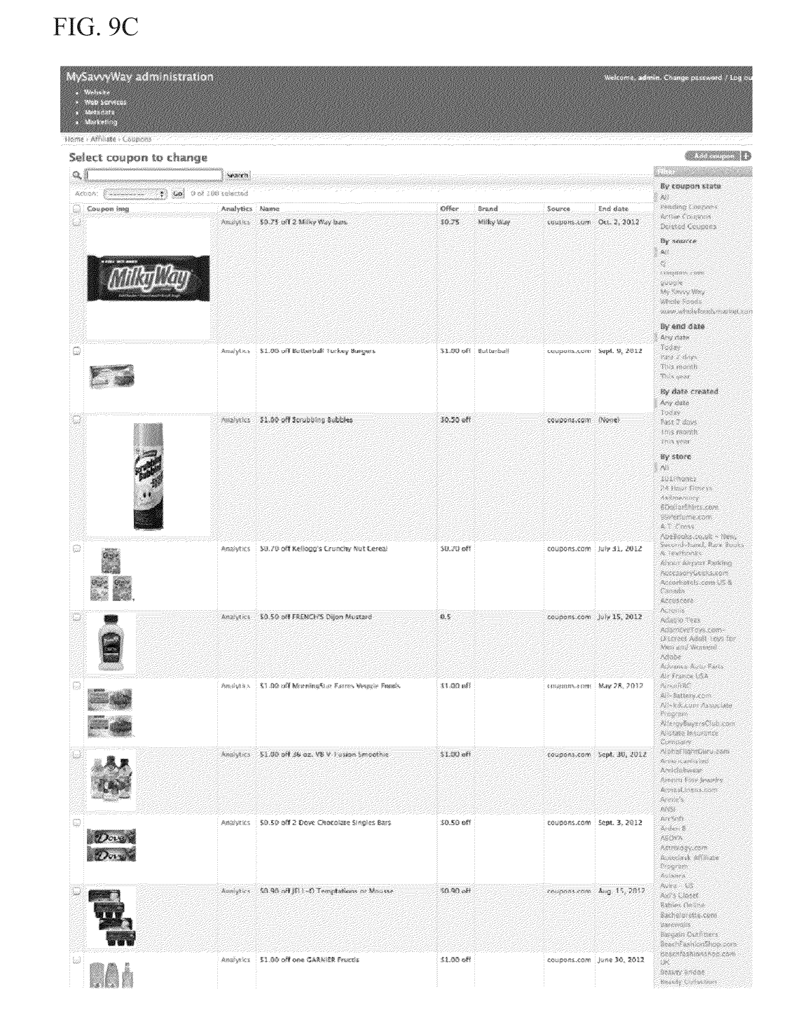

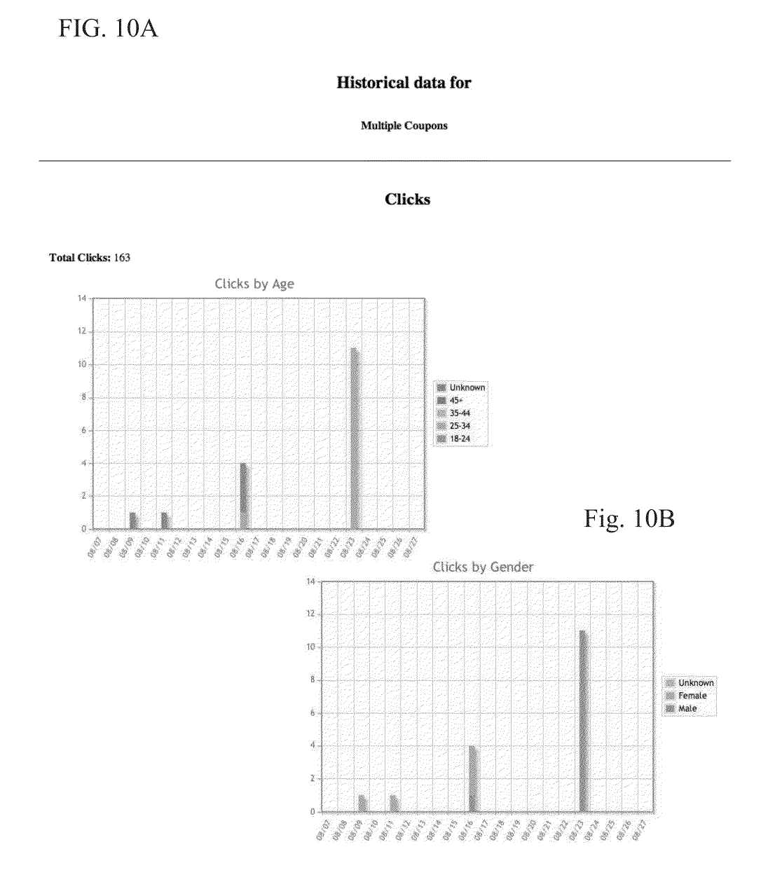

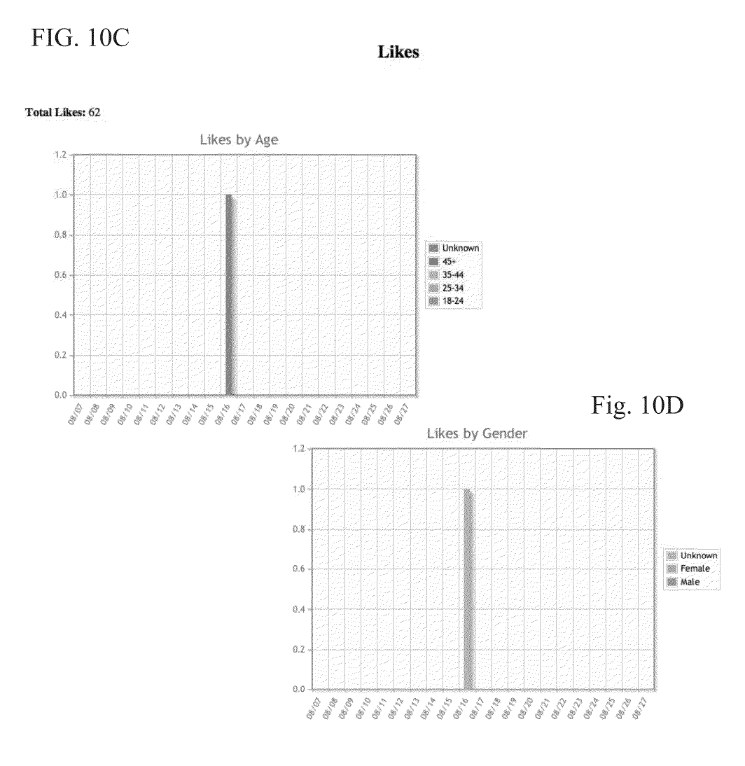

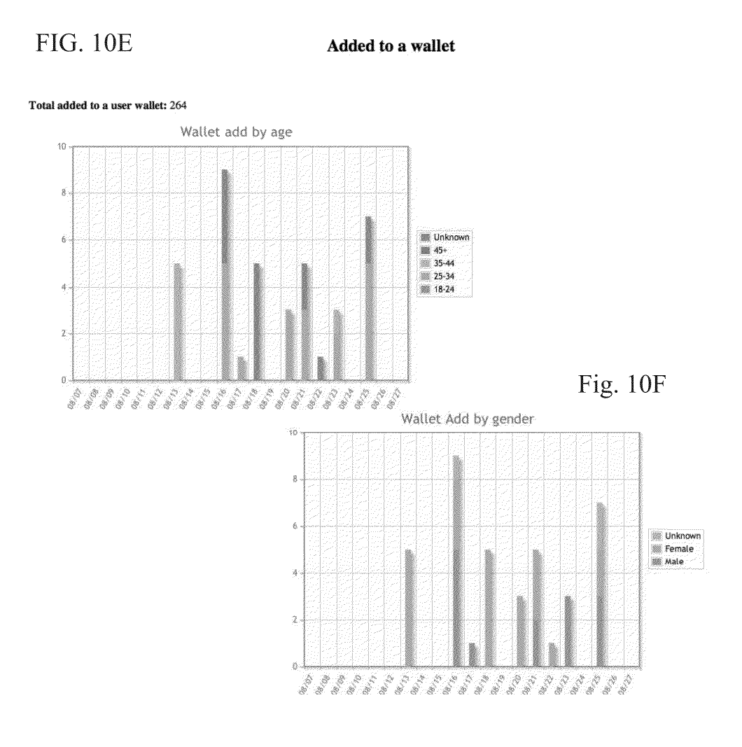

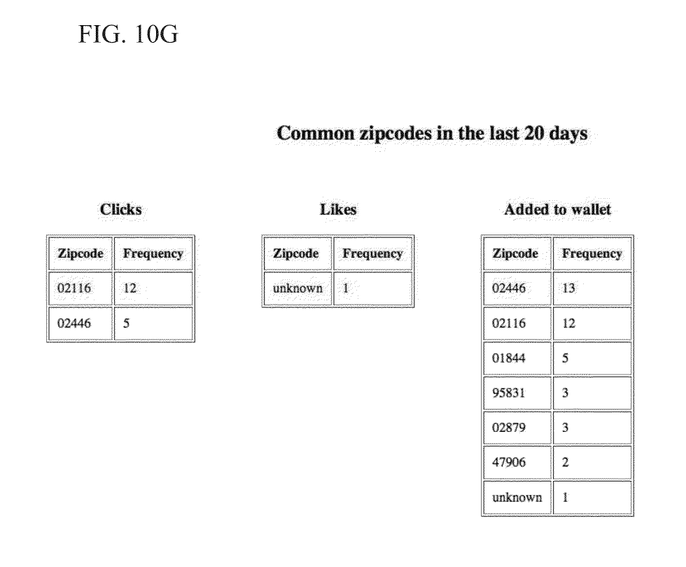

FIGS. 9A-9C are screenshots of the administration API 290 (see FIG. 4). FIGS. 10A-10F shows the historical data of the number of clicks broken by age group (FIG. 10A) and gender (FIG. 10B). Total likes is shown by age group (FIG. 10C) and gender (FIG. 10D). FIG. 10E shows a graph of the number of times a promotion was added to a user's wallet, broken down by age group. FIG. 10F shows a graph of the number of times a promotion was added to a user's wallet broken down by gender. FIG. 10G is a chart of different events (e.g. Clicks, Likes, and Added to Wallet) by zip code.

Other geographic terms or boundaries can be used herein, such as town/city, county, state, area code number, etc.

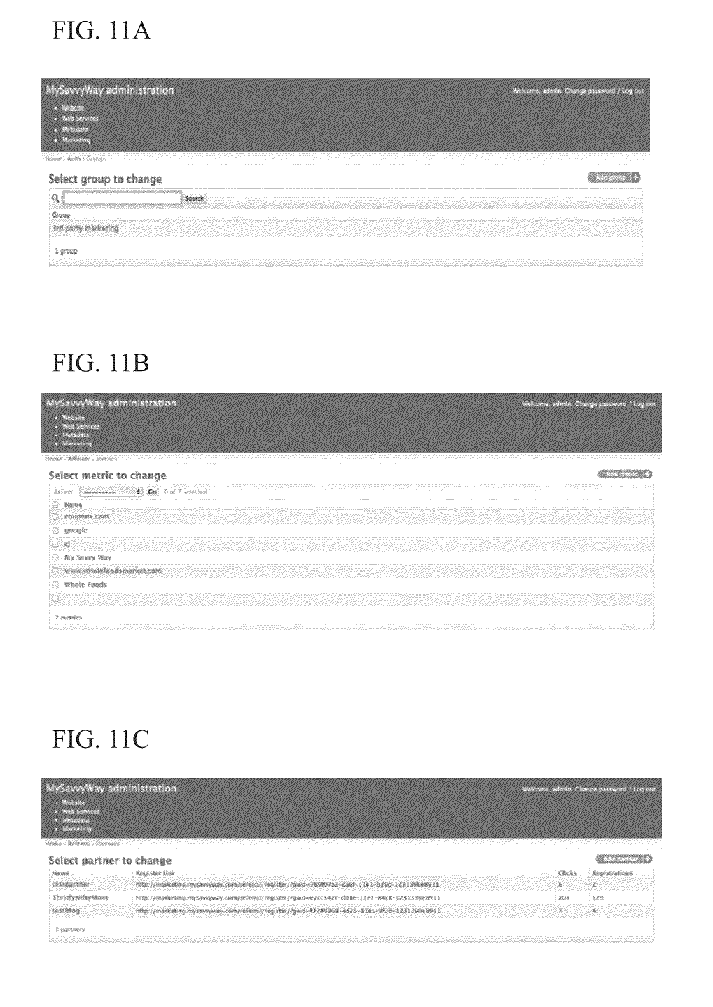

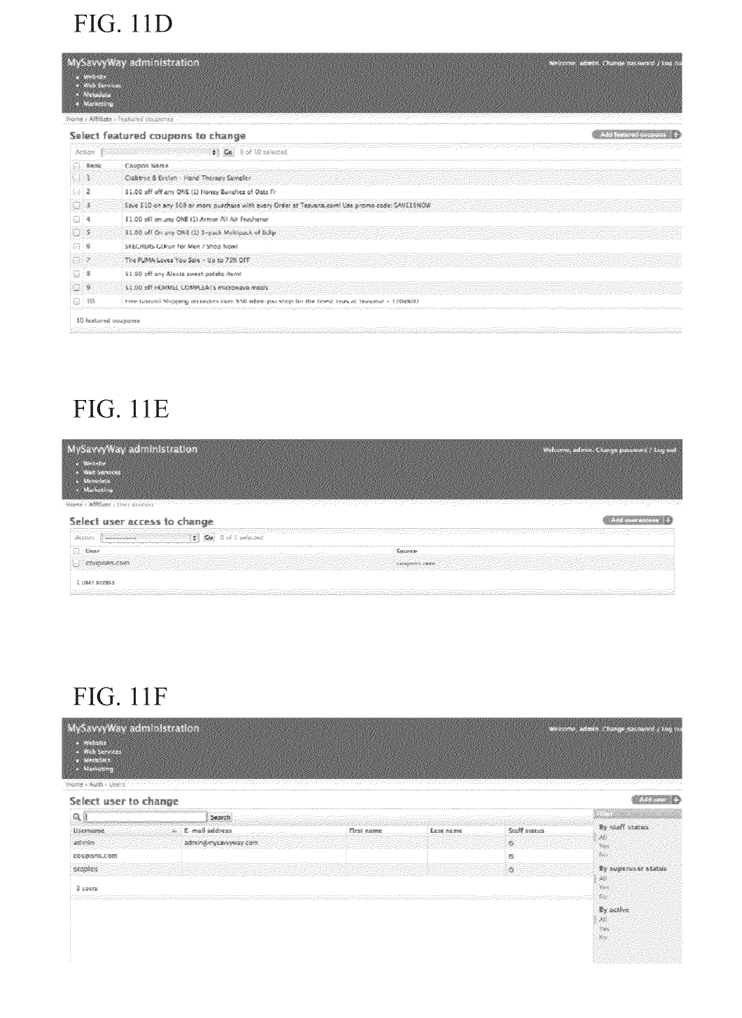

FIGS. 11A-11F are additional screenshots of the administration API 290 (see FIG. 4).

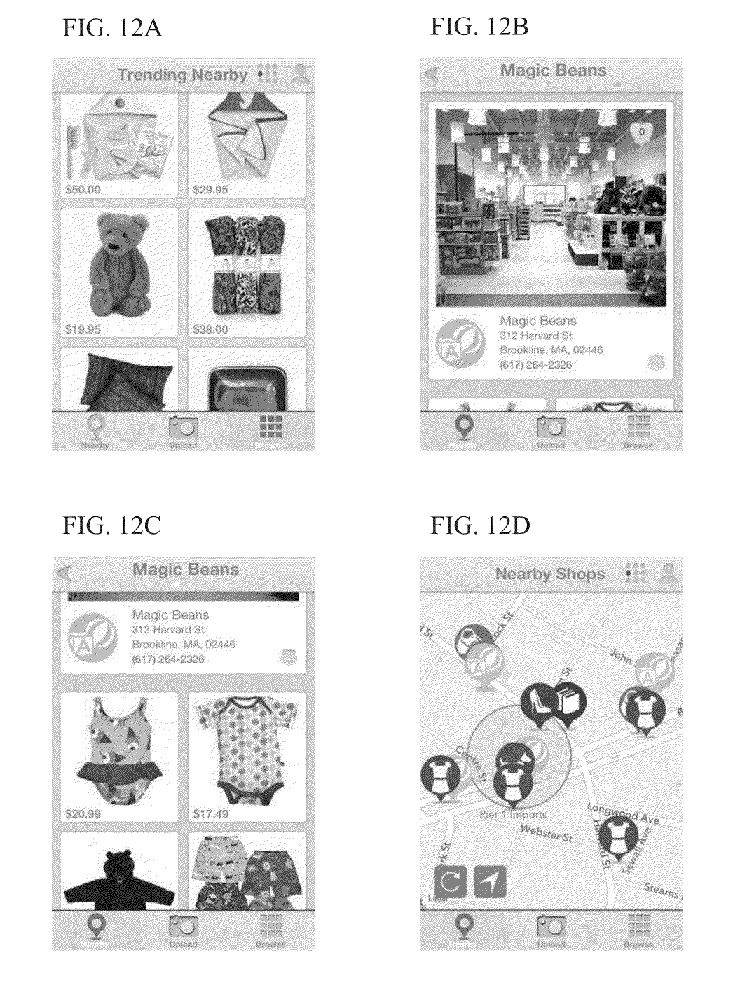

FIGS. 12A-12D are screenshots of another embodiment of the present invention on a mobile device running iOS.

While this invention has been particularly shown and described with references to example embodiments thereof, it will be understood by those skilled in the art that various changes in form and details may be made therein without departing from the scope of the invention encompassed by the appended claims.

What is claimed is:

1. A computer and mobile-based system of managing and publishing promotions comprising:
(a) a source of promotional data;
(b) a cloud server storing and indexing said promotional data; and
(c) a web service application programming interface coupling the cloud server to an electronic device of a user and enabling the user through the electronic device to access the promotional data stored on the cloud server.

2. The system of claim 1, further comprising a promotional distribution based on user preferences and predictive models based on the user.

3. The system of claim 1, wherein the promotional data comprises information from a physical offer, electronic offer, or a gift card.

4. The system of claim 1, wherein the promotional data comprises information from a daily deal.

5. The system of claim 3, wherein the promotional data comprises information from a photo of a physical promotion uploaded to the cloud server by the user.

6. The system of claim 1, wherein the promotional data comprises information shared by a friend, family member, blogger, retailer, merchant, or other 3^{rd} party.

7. The system of claim 1, wherein the user receives recommended offers based on a targeting and/or a predictive algorithm.

8. The system of claim 7, wherein the targeting algorithm predicts and suggests promotions to the user based on any combinations of: preferences, behavior, demographics, types of promotions, stores/websites, geographic location of the store, and geographic location of the user.

9. The system of claim 1, wherein the source of promotional data is from a user uploading a photo of a physical promotion—whether it be products, offers, coupons, or sales—or a user manually inputting promotional data.

10. The system of claim 1, wherein the user accessing the promotional data further comprises viewing the promotional data based on any one of the following: name of store issuing promotion, address of the store issuing the promotion, name of the promotion, the amount of the promotion, expiration date, limitations of quantity purchased, type of product, and location.

11. The system of claim 1, wherein the electronic device is any of a mobile device, smart phone, cell phone, tablet, or personal computer.

12. The system of claim 1, wherein the web service application programming interface further comprises enabling the user to redeem, delete, or share a promotion stored on the cloud server.

13. The system in claim 1, wherein a merchant distributes one or more tasks to the electronic device of the user to display products and/or promotions for the merchant.

14. The system of claim 13, wherein the user earns credits, rewards, or predetermined wage amounts as a payment for the user for completing the one or more tasks.

15. A computer-based system for promotional marketing comprising:
(a) a consumer-user database;
(b) a promotion database; and
(c) a targeting algorithm;
wherein the consumer-user database comprises online session information from consumer-users; and wherein the promotion database comprises local and global information from advertising-users and aggregated metrics based on promotion usage and promotion data.

16. The system of claim 15, wherein the targeting algorithm further generates a personalized promotional offer to consumer-user, wherein the personalized offer is based on any combinations of: consumer-user behavior, preferences, usage, stores shopped at and geographic location of the consumer-user.

17. A method of managing and publishing promotions comprising:
(a) accessing a source of promotional data;
(b) indexing a cloud server that stores and indexes said promotional data; and
(c) executing a web service application programming interface that couples the cloud server to an electronic device of a user and enabling the user through the electronic device to access the promotional data stored on the cloud server.
